(19) United States
(12) Patent Application Publication
(10) Pub. No.: US 2025/0360638 A1
(43) Pub. Date: Nov. 27, 2025

(54) ATTACHMENT OF CUTTING DEVICE AND CUTTING DEVICE TO WHICH ATTACHMENT IS ATTACHED

(71) Applicant: Panasonic Intellectual Property Management Co., Ltd., Osaka (JP)

(72) Inventors: YUSAKU SHUTTA, Kyoto (JP); WEI WANG, Shiga (JP); NOBUHIKO MORIOKA, Shiga (JP); YUTA TOYOHARA, Shiga (JP)

(21) Appl. No.: 19/204,403

(22) Filed: May 9, 2025

(30) Foreign Application Priority Data
May 24, 2024 (JP) 2024-084869

(51) Int. Cl. B26B 19/20; B26B 19/38

(52) U.S. Cl. CPC B26B 19/20; B26B 19/3813; B26B 19/386

(57) ABSTRACT

An attachment for a cutting device further improves the sliding properties of the skin contact surface on the skin. Such a cutting device to which the attachment is also included in the present disclosure. The attachment according to the present disclosure includes a base, a comb part with which the base is provided and which protrudes in second directions intersecting first directions, and a pair of sandwiching walls with which the base is provided and which sandwich the cutting device from both sides in third directions intersecting the first directions and the second directions. Here, the comb part includes a facing surface positioned on one side in the first directions to face a blade part and a skin contact surface positioned on the other side in the first directions to come into contact with skin. The skin contact surface is provided with an uneven part.

### BACKGROUND

### 1. Technical Field

The present disclosure relates to an attachment of a cutting device and a cutting device to which the attachment is attached.

### 2. Description of the Related Art

Conventionally, as shown in PTL 1, an attachment that can be attached to a cutting device has been proposed.

In PTL 1, an attachment is detachably attached to an electric hair clipper as a cutting device, and hair can be cut to a desired uniform length by sliding the attachment on the skin in a state where a skin contact surface of the attachment is in contact with the skin.

### CITATION LIST

### Patent Literature

PTL 1: Unexamined Japanese Patent Publication No. 2014-124320

### SUMMARY

In the attachment used to slide on the skin in a state where the skin contact surface is in contact with the skin like this, it is preferable to improve the sliding properties.

An object of the present disclosure is to obtain an attachment of a cutting device capable of further improving the sliding properties of the skin contact surface on the skin and a cutting device to which the attachment is attached.

An attachment of a cutting device according to one aspect of the present disclosure is an attachment for a cutting device including a blade part, the attachment being configured to be attached to and detached from the cutting device by moving the attachment in a first direction relatively to the cutting device, the attachment including a base; a comb part including a facing surface and a skin contact surface, the facing surface being configured to face the blade part, the skin contact surface being configured to come into contact with a skin, the base being provided with the comb part, the comb part projecting in a second direction intersecting the first direction; and a pair of sandwiching walls, the base being provided with the pair of sandwiching walls, the pair of sandwiching walls being configured to sandwich the cutting device in a third direction which intersects the first direction and the second direction, wherein the skin contact surface is provided with an uneven part.

To a cutting device according to one aspect of the present disclosure, the attachment is attached.

The present disclosure can obtain an attachment of a cutting device capable of further improving the sliding properties of the skin contact surface on the skin and a cutting device to which the attachment is attached.

### BRIEF DESCRIPTION OF THE DRAWINGS

FIG. 1 is a perspective view schematically illustrating an example of a cutting device according to an exemplary embodiment.

FIG. 2 is a front view schematically illustrating an example of a body in the exemplary embodiment.

FIG. 3 is a plan view schematically illustrating an example of the body in the exemplary embodiment.

FIG. 4 is a horizontal sectional view schematically illustrating an example of the body in the exemplary embodiment.

FIG. 5 is a side sectional view schematically illustrating an example of the body in the exemplary embodiment.

FIG. 6 is a side sectional view schematically illustrating an example of a head in the exemplary embodiment.

FIG. 7 is a perspective view schematically illustrating an example of the cutting device according to the exemplary embodiment and an example of an attachment in a state of not being attached to the cutting device.

FIG. 8 is a perspective view schematically illustrating a state in which an example of the attachment according to the exemplary embodiment is viewed from the rear surface thereof.

FIG. 9 is a plan view schematically illustrating an example of the attachment according to the exemplary embodiment.

FIG. 10 is a front view schematically illustrating an example of the attachment according to the exemplary embodiment.

FIG. 11 is a rear view schematically illustrating an example of the attachment according to the exemplary embodiment.

FIG. 12 is a sectional view taken along line A-A in FIG. 9.

FIG. 13 is a sectional view taken along line B-B in FIG. 9.

FIG. 14 is a perspective view schematically illustrating a skin contact surface of a comb part as an example of the attachment according to the exemplary embodiment.

FIG. 15 is a sectional view taken along line C-C in FIG. 9.

FIG. 16 is an enlarged view illustrating a textured part formed in the comb part as an example of the attachment according to the exemplary embodiment.

FIG. 17 is a perspective view schematically illustrating a state in which an engaged part of the cutting device is engaged with an engagement part provided on a tip of a first selective engagement group provided in an example of the attachment according to the exemplary embodiment.

FIG. 18 is a plan view schematically illustrating the state in which the engaged part of the cutting device is engaged with the engagement part provided at the tip of the first selective engagement group provided in an example of the attachment according to the exemplary embodiment.

FIG. 19 is a sectional view taken along line D-D in FIG. 18.

FIG. 20 is a perspective view schematically illustrating a state in which the engaged part of the cutting device is engaged with the engagement part provided on a base of the first selective engagement group provided in an example of the attachment according to the exemplary embodiment.

FIG. 21 is a plan view schematically illustrating the state in which the engaged part of the cutting device is engaged with the engagement part provided on the base of the first selective engagement group provided in an example of the attachment according to the exemplary embodiment.

FIG. 22 is a sectional view taken along line E-E in FIG. 21.

FIG. 23 is a perspective view schematically illustrating a state in which the engaged part of the cutting device is engaged with the engagement part provided on a tip of a second selective engagement group provided in an example of the attachment according to the exemplary embodiment.

FIG. 24 is a plan view schematically illustrating the state in which the engaged part of the cutting device is engaged with the engagement part provided at the tip of the second selective engagement group provided in an example of the attachment according to the exemplary embodiment.

FIG. 25 is a sectional view taken along line F-F in FIG. 24.

FIG. 26 is a perspective view schematically illustrating a state in which the engaged part of the cutting device is engaged with the engagement part provided at a center of the second selective engagement group provided in an example of the attachment according to the exemplary embodiment.

FIG. 27 is a plan view schematically illustrating the state in which the engaged part of the cutting device is engaged with the engagement part provided at the center of the second selective engagement group provided in an example of the attachment according to the exemplary embodiment.

FIG. 28 is a sectional view taken along line G-G in FIG. 27.

FIG. 29 is a perspective view schematically illustrating a state in which the engaged part of the cutting device is engaged with the engagement part which is provided close to the base and included in the second selective engagement group provided in an example of the attachment according to the exemplary embodiment.

FIG. 30 is a plan view schematically illustrating the state in which the engaged part of the cutting device is engaged with the engagement part which is provided close to the base and included in the second selective engagement group provided in an example of the attachment according to the exemplary embodiment.

FIG. 31 is a sectional view taken along line H-H in FIG. 30.

FIG. 32 is a plan view illustrating an attachment according to a first modification.

FIG. 33 is a sectional view taken along line I-I in FIG. 32.

FIG. 34 is a plan view illustrating an attachment according to a second modification.

FIG. 35 is a sectional view taken along line J-J in FIG. 34.

FIG. 36 is a plan view illustrating an attachment according to a third modification.

FIG. 37 is a sectional view taken along line K-K in FIG. 36.

### DETAILED DESCRIPTION

Hereinafter, exemplary embodiment will be described in detail with reference to the drawings. Unnecessarily detailed description may be omitted. For example, a detailed description of a well-known matter or a repeated description of a substantially identical configuration may be omitted.

The attached drawings and the following description are provided for those skilled in the art to fully understand the present disclosure, and are not intended to limit the subject matter as described in the appended claims.

In the following exemplary embodiments, a hair clipper that cuts human hair and animal hair is exemplified as a cutting device.

In the following exemplary embodiments, a description will be given assuming that an attachment and detachment direction of an attachment to and from the cutting device is Z direction, a direction in which a comb part projects is X direction, and a direction intersecting (for example, orthogonal to) the X direction and the Z direction is Y direction. In the present disclosure, the Z direction may be referred to as an up-down direction or a first direction. The X direction may be referred to as a front-rear direction or a second direction. The Y direction may be referred to as a width direction or a third direction.

The description will be given by defining the up-down direction of the attachment in a state where the attachment is positioned below the cutting device and the cutting device is positioned on or above the attachment.

In the following exemplary embodiments, the side where a first comb part projects is defined as a front side (that is, the front side in the X direction) of the attachment for convenience.

The configuration of each member of the cutting device will be described by defining the longitudinal direction of a body as the up-down direction, defining the side of the body on which a power switch is provided as the front direction of the front-rear direction, and defining the direction orthogonal to the up-down direction and the front-rear direction as the width direction. The description will be given by defining a direction from the body to a head as the upward direction of the up-down direction.

### Exemplary Embodiment

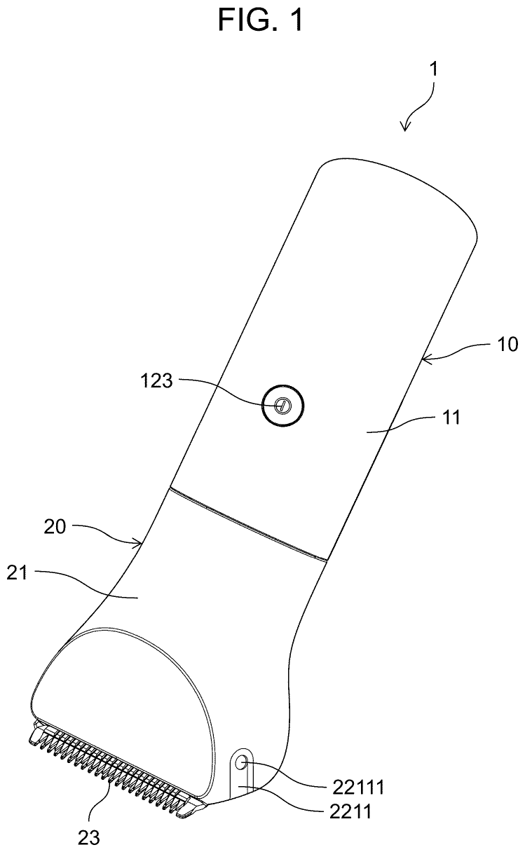

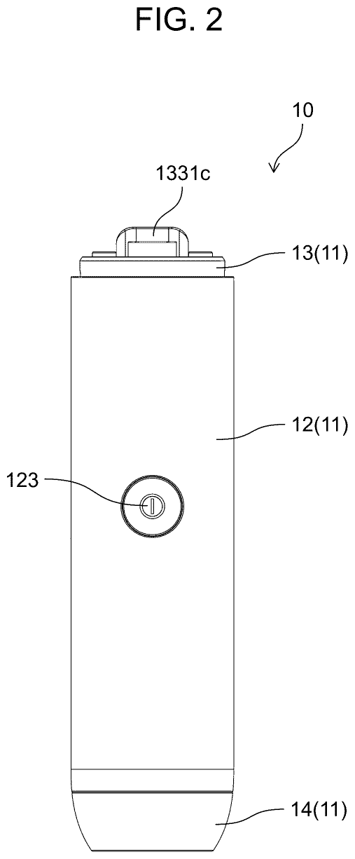

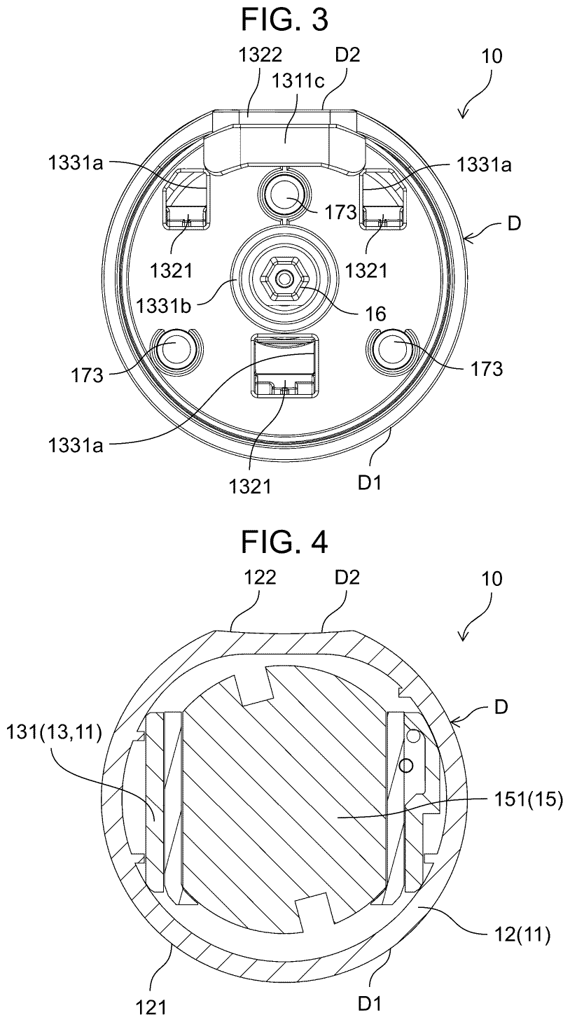

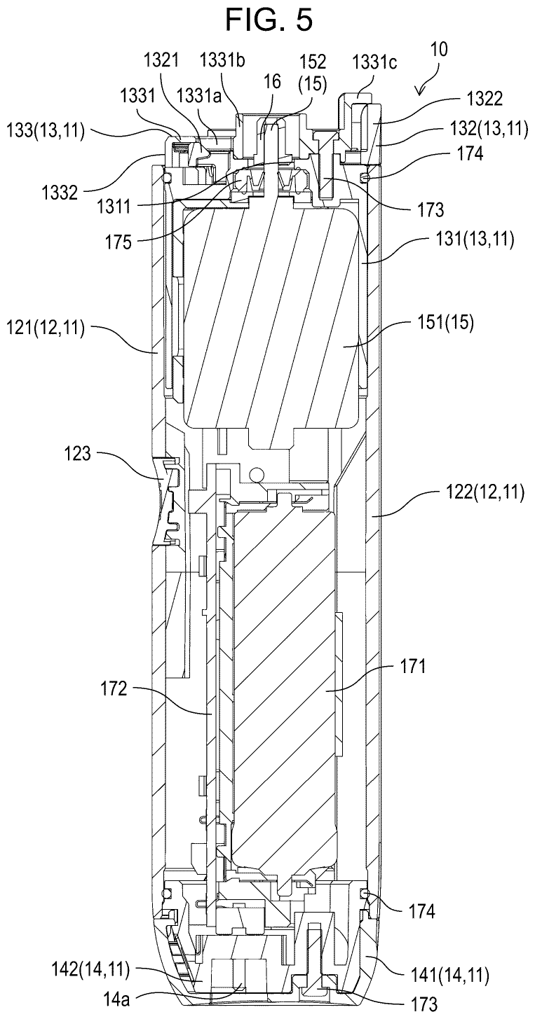

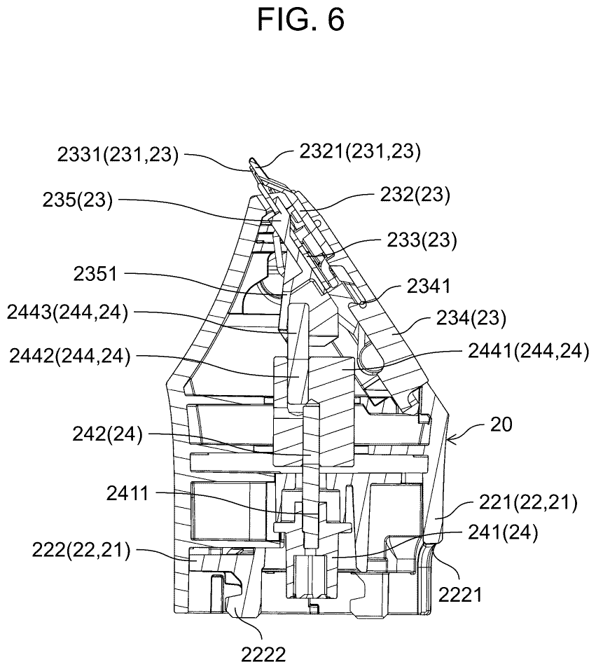

FIG. 1 is a perspective view schematically illustrating an example of a cutting device (for example, hair clipper 1) according to an exemplary embodiment. FIG. 2 is a front view schematically illustrating an example of body 10 in the exemplary embodiment. FIG. 3 is a plan view schematically illustrating an example of body 10 in the exemplary embodiment. FIG. 4 is a horizontal sectional view schematically illustrating an example of body 10 in the exemplary embodiment. FIG. 5 is a side sectional view schematically illustrating an example of body 10 in the exemplary embodiment. FIG. 6 is a side sectional view schematically illustrating an example of head 20 in the exemplary embodiment. As illustrated in FIGS. 1 to 6, hair clipper 1 (that is, an example of the cutting device) according to the present exemplary embodiment includes body 10 having drive shaft 16 driven by rotary motor 15, and head 20 provided with blade unit 23. Head 20 is detachably attached to body 10. The hair clipper 1 is a device that can be used, for example, when hair H (that is, an example of body hair) of a user is cut to a desired length.

### Example of Configuration of Body

Here, an example of the configuration of body 10 will be described.

Body 10 has a columnar shape elongated in the up-down direction, and is formed in a size that allows a user to hold body 10 with one hand. That is, when using hair clipper 1, the user can grip body 10 and use the hair clipper.

In the present exemplary embodiment, as illustrated in FIGS. 2 to 5, body 10 includes housing 11 constituting an outer shell. This housing 11 may be formed using, for example, an insulating synthetic resin material.

In the present exemplary embodiment, housing 11 is formed by joining a plurality of divided bodies, and a cavity is formed inside housing 11 formed by joining the divided bodies. Various electric components are contained in the cavity.

Specifically, as illustrated in FIG. 2, housing 11 includes cylindrical wall 12, which is substantially cylindrical and penetrating in the up-down direction, upper lid 13 disposed to cover the upper opening of cylindrical wall 12, and lower lid 14 disposed to cover the lower opening of cylindrical wall 12.

Here, in the present exemplary embodiment, as illustrated in FIGS. 3 and 4, a surface having a curvature different from those of the other portions is formed at the rear portion of cylindrical wall 12 in the front-rear direction to extend in an elongated manner in the up-down direction. That is, cylindrical wall 12 has first surface 121 curved in an arc shape and second surface 122 formed continuously with both ends of first surface 121 with a curvature different from that of first surface 121. In the present exemplary embodiment, the curvature of second surface 122 is smaller than that of first surface 121. Specifically, the curvature of second surface 122 is substantially 0, and second surface 122 is formed to be a substantially flat surface. At this time, second surface 122 may be formed to have the same curvature at any position in the up-down direction (that is, axial direction of drive shaft 16). Second surface 122 may be formed such that the curvature at any position in the up-down direction (that is, the axial direction of drive shaft 16) is different from those of other portions. In the present exemplary embodiment, as illustrated in FIGS. 3 and 4, second surface 122 is formed to be a flat surface (that is, the curvature is zero) at a portion where vertical wall 1322 is formed, and to be a recessed surface slightly curved inward (that is, toward drive shaft 16) at other portions.

Further, in the present exemplary embodiment, the outer peripheral surface of cylindrical wall 12 forms contour shape D of body 10 as viewed from the up-down direction (that is, the axial direction of drive shaft 16). Thus, in the present exemplary embodiment, as illustrated in FIGS. 4 and 5, contour shape D of body 10 as viewed from the up-down direction (that is, the axial direction of drive shaft 16) has a shape including arc-shaped first line D1 having a predetermined curvature, and second line D2 having a curvature different from that of first line D1. Here, in the present exemplary embodiment, the curvature of second line D2 is smaller than that of first line D1. Specifically, the curvature of second line D2 is substantially 0, and second line D2 is formed to be a substantially straight line. As described above, in the present exemplary embodiment, second surface 122 is formed to be a flat surface at a portion where vertical wall 1322 is formed, and to be a recessed surface at other portions. Thus, second line D2 is a straight line at a portion where vertical wall 1322 is formed, and an arc line curved inward at other portions. Body 10 thus has a shape of a D-cut structure.

As just described, when body 10 has a shape of a D-cut structure, the front-rear direction of body 10 can be easily distinguished when body 10 is held. When body 10 has a shape of a D-cut structure, body 10 can be prevented from rolling when body 10 is placed on a wash basin.

In the present exemplary embodiment, as illustrated in FIG. 5, rotary motor 15, rechargeable battery 171 that supplies power to rotary motor 15, and control board 172 that controls on and off of a power supply (more specifically, on and off of driving of rotary motor 15), are contained in the cavity formed inside housing 11.

Specifically, rotary motor 15 is contained in an upper part of housing 11, and rechargeable battery 171 is contained in a lower part of housing 11, that is, a lower part of rotary motor 15, in a state where the longitudinal direction of rechargeable battery 171 are substantially identical to the up-down direction. As just described, body 10 may be made compact in the width direction when rotary motor 15 and rechargeable battery 171 are disposed to be parallel in the up-down direction. Then, control board 172 is contained in front of rechargeable battery 171 in the cavity of housing 11.

Rotary motor 15 includes rotary motor body 151 and rotary motor shaft 152, and is contained in the cavity of housing 11 in a state where rotary motor shaft 152 projects upward from rotary motor body 151. That is, rotary motor 15 is contained in the cavity of housing 11 in a state where the direction of axis of rotation are substantially identical to the up-down direction. Drive shaft 16 is attached to rotary motor shaft 152 projecting upward.

As rechargeable battery 171, a lithium ion rechargeable battery, or a nickel metal hydride rechargeable battery may be used.

Pressing-type power switch 123 that switches on and off of the power supply (more specifically, on and off of driving of rotary motor 15) is formed at a substantially central portion in the front portion of cylindrical wall 12 in the up-down direction to face control board 172. In the present exemplary embodiment, pressing-type power switch 123 is exemplified as the power switch, but other switches including a sliding type may be used as long as the power supply is turned on and off with the switch.

Upper lid 13 is a wall disposed to cover the upper opening of cylindrical wall 12. Upper lid 13 includes rotary motor holding wall 131 that holds rotary motor 15. Further, upper lid 13 includes movable wall 132 disposed above rotary motor holding wall 131 to be slidable in the front-rear direction, and retaining wall 133 that suppresses relative movement of movable wall 132 in the up-down direction. In the present exemplary embodiment, upper lid 13 is formed by fixing rotary motor holding wall 131 and retaining wall 133 with screw 173 in a state where movable wall 132 is sandwiched between rotary motor holding wall 131 and retaining wall 133.

Rotary motor holding wall 131 is inserted into cylindrical wall 12 from the upper opening of cylindrical wall 12 in a state where rotary motor holding wall 131 faces downward. Thus, the upper opening of cylindrical wall 12 is covered with upper lid 13. At this time, rotary motor holding wall 131 is inserted into cylindrical wall 12 in a state where a gap between the outer peripheral surface of rotary motor holding wall 131 and the inner peripheral surface of cylindrical wall 12 is sealed by packing 174.

Through-hole 1311 is formed in rotary motor holding wall 131 at a position corresponding to drive shaft 16, and rotary motor 15 is held by rotary motor holding wall 131 in a state where drive shaft 16 attached to rotary motor shaft 152 is inserted into through-hole 1311. At this time, rotary motor 15 is held by rotary motor holding wall 131 in a state where a gap between rotary motor shaft 152 and through-hole 1311 is sealed by waterproof rubber 175. This makes it possible to prevent water from entering the cavity of housing 11 when body 10 is washed with water, for example.

Further, in the present exemplary embodiment, a plate material is not present at a position corresponding to drive shaft 16 in movable wall 132 or retaining wall 133, and drive shaft 16 is exposed to the outside at least in plan view of body 10 (that is, in a state where the body is viewed from the upward direction of the up-down direction). This makes it possible to attach power transmission unit 241, which will be described later and provided in head 20, to drive shaft 16 when head 20 is connected to body 10.

As illustrated in FIG. 3, drive shaft 16 has a polygonal shape (more specifically, a regular hexagonal shape) in plan view of body 10 (that is, in a state where the body is viewed from the upward direction of the up-down direction), and power transmission unit 241 can be attached to drive shaft 16 in a state where idling is suppressed. Drive shaft 16 and power transmission unit 241 only require to be attached in a state where idling is suppressed, and the shapes of drive shaft 16 and power transmission unit 241 are not limited to a polygonal shape. For example, it is also possible to use a drive shaft to which a D-cut structure such as body 10 described above is applied, that is, a drive shaft having a D-cut structure. Idling may also be suppressed by using a means for increasing frictional force between drive shaft 16 and power transmission unit 241.

In the present exemplary embodiment, when head 20 is attached to body 10, hook 1321 (that is, an example of fitting part) to be fitted to hook 2222 (that is, an example of fitting part) provided on head 20 is provided on movable wall 132 so as to project upward.

In the present exemplary embodiment, as illustrated in FIGS. 3 and 5, a plurality of (here, three) hooks 1321 are provided on movable wall 132 in a state of being separated from each other. Each of these three hooks 1321 is provided such that a portion for hooking hook 2222 projects in the rear direction of the front-rear direction.

Further, at the rear end of movable wall 132, vertical wall 1322 standing to extend upward is provided. By pushing vertical wall 1322 in the front direction of the front-rear direction, hook 1321 (that is, one element of movable wall 132) moves forward relative to rotary motor holding wall 131 and retaining wall 133.

By providing such hook 1321 and vertical wall 1322 on movable wall 132, vertical wall 1322 functions as a release button for releasing the fitting between hook 1321 and hook 2222.

In the present exemplary embodiment, retaining wall 133 includes top wall 1331 that covers movable wall 132 from above, and peripheral wall 1332 that extends downward from outer peripheral edge of top wall 1331. In top wall 1331, through-hole 1331a is formed where at least a part of hook 1321 is exposed in plan view of body 10 and hook 2222 on head 20 is inserted when head 20 is attached to body 10. Cylindrical rib 1331b projecting upward to surround the entire circumference of drive shaft 16 is formed on top wall 1331. Cylindrical rib 1331b functions as guiding the linking between drive shaft 16 and power transmission unit 241 when head 20 is attached to body 10. Further, restriction wall 1331c that restricts excessive forward movement of vertical wall 1322 is formed in top wall 1331.

Peripheral wall 1332 is a portion to be inserted into a peripheral wall (as an example, upper wall 221) of head 20 when head 20 is attached to body 10.

In the present exemplary embodiment, body 10 and head 20 are provided with vibration receivers configured to receive vibration in three or more directions intersecting each other on a plane orthogonal to drive shaft 16. This allows the vibration to be reduced when any of the various heads vibrating in different directions is attached to body 10.

In the present exemplary embodiment, three hooks 1321 and three hooks 2222 (that is, an example of the fitting part) respectively provided in body 10 and head 20 also serve as vibration receivers.

Hooks 1321, 2222 (that is, an example of the fitting part) may be provided at four or more locations of body 10 and head 20.

It is preferable to provide three or more hooks 1321, 2222 (that is, an example of the fitting part) so as to be positioned on one virtual circumference centered on drive shaft 16. At this time, it is more preferable to provide the hooks at equal intervals on the one virtual circumference centered on drive shaft 16.

When the fitting part is provided to surround drive shaft 16 over the entire circumference, vibration in various directions can be received by one fitting part. Also by providing two semicircular fitting parts to surround drive shaft 16, vibration in various directions can be received.

In addition to the fitting part, it is also possible to provide vibration receivers configured to receive vibration in three or more directions intersecting each other on a plane orthogonal to drive shaft 16.

As illustrated in FIG. 5, lower lid 14 is a wall disposed to cover the lower opening of cylindrical wall 12, and includes outer wall 141 having a shape of substantially truncated sphere having a diameter which decreases downward, and inner wall 142 disposed inside outer wall 141. In the present exemplary embodiment, lower lid 14 is formed by fixing outer wall 141 and inner wall 142 with screw 173.

By inserting the upper portion of inner wall 142 into cylindrical wall 12 from the lower opening of cylindrical wall 12, the lower opening of cylindrical wall 12 is covered with lower lid 14. At this time, the upper portion of inner wall 142 is inserted into cylindrical wall 12 in a state where a gap between the outer peripheral surface of the upper portion of inner wall 142 and the inner peripheral surface of cylindrical wall 12 is sealed by packing 174.

In addition, connector 14a is formed on the lower surface of lower lid 14, into which a charging cable (not illustrated) can be inserted. That is, rechargeable battery 171 can be charged by inserting a charging cable into connector 14a. The method of charging rechargeable battery 171 is not limited to the method of inserting a charging cable into connector 14a, and may be, for example, a charging method with contactless power supply or a charging method with long-distance power transmission using a power transmission system.

### Example of Configuration of Head

Next, an example of a configuration of head 20 will be described.

Head 20 in the present exemplary embodiment includes head body 21 detachably attached to body 10, and blade unit 23 detachably attached to head body 21.

Head body 21 includes head housing 22 constituting an outer shell of head body 21. Head housing 22 may be formed using, for example, an insulating synthetic resin material.

Head housing 22 is formed by joining a plurality of divided bodies, and a cavity is formed inside head housing 22 formed by joining the divided bodies. As illustrated in FIG. 6, conversion mechanism 244, which will be described later is contained in the cavity.

Head housing 22 includes upper wall 221 that opens downward and lower lid 222 that is disposed to cover the lower opening of upper wall 221. In the present exemplary embodiment, upper wall 221 and lower lid 222 are integrally formed.

Cutout 2221 is formed at the rear lower end of lower lid 222, and lower lid 222 does not interfere with restriction wall 1331c and vertical wall 1322 of body 10 when head 20 is attached to body 10. In addition, restriction wall 1331c, vertical wall 1322, and cutout 2221 define one attachment direction of head 20 when head 20 is attached to body 10.

Lower lid 222 is a wall disposed to cover the lower opening of upper wall 221, and three hooks 2222 (that is, an example of the fitting part) are provided on lower lid 222 so as to project downward. Three hooks 2222 are provided at positions corresponding to three hooks 1321 of body 10, respectively, and are each provided so that a portion for hooking hook 1321 projects in the front direction of the front-rear direction.

Lower lid 222 holds power transmission unit 241 of power transmission mechanism 24 so as to be surrounded by three hooks 2222. A space having a polygonal shape (more specifically, a regular hexagonal shape) in rear view (that is, in a state where head 20 is viewed from the downward direction of the up-down direction) of head 20 is formed inside power transmission unit 241 to open downward. This space having a polygonal shape (more specifically, a regular hexagonal shape) is formed to have substantially the same size as an outer diameter of drive shaft 16, and when head 20 is attached to body 10, drive shaft 16 is inserted into the space having a polygonal shape (more specifically, a regular hexagonal shape).

Head 20 is provided with power transmission mechanism 24 having power transmission unit 241 described above and is configured to transmit power (i.e., rotational force) of rotary motor 15.

Power transmission mechanism 24 includes operation shaft 242 attached to power transmission unit 241 to operate. Operation shaft 242 is inserted into and fixed to insertion hole 2411 formed in the upper portion of power transmission unit 241, and rotates together with power transmission unit 241 that rotates with the power (for example, the rotational force) of rotary motor 15 transmitted from drive shaft 16.

Power transmission mechanism 24 is held by upper wall 221 in a state where the upper end of operation shaft 242 is disposed in a cavity in which conversion mechanism 244 is contained.

In addition, power transmission mechanism 24 includes conversion mechanism 244 that is attached to operation shaft 242 and converts the rotational motion into a reciprocating linear motion in the width direction, and conversion mechanism 244 is linked to holding plate 235 (that is, an example of an action part), which will be described later. That is, conversion mechanism 244 is interposed between operation shaft 242 and holding plate 235 (that is, an example of the action part). This allows holding plate 235 (that is, an example of the action part) to be reciprocated linearly in the width direction by using the power of rotary motor 15.

Conversion mechanism 244 includes base 2441 attached to the upper end of operation shaft 242. Base 2441 is attached to operation shaft 242 to rotate together with operation shaft 242.

Conversion mechanism 244 includes eccentric shaft 2442 attached to base 2441 in a state of being eccentric with respect to operation shaft 242, and link 2443 attached to eccentric shaft 2442 and linked to connection part 2351 of holding plate 235 (that is, an example of the action part).

This allows the rotational motion of rotary motor 15 to be converted into the reciprocating motion of holding plate 235 (that is, an example of the action part) in the width direction.

Blade unit 23 is detachably attached to head body 21 having such a configuration.

Blade unit 23 is provided with blade part 231, and has a function of cutting hair. In head 20 according to the present exemplary embodiment, blade part 231 has a width larger than a diameter of body 10.

Blade part 231 includes fixed blade 2321 and movable blade 2331 that reciprocates and slides with respect to fixed blade 2321. Movable blade 2331 is configured to reciprocate with respect to fixed blade 2321 in the width direction.

Specifically, blade unit 23 includes fixing plate 232 on which a plurality of fixed blades 2321 are formed, and movable plate 233 on which a plurality of movable blades 2331 are formed. Blade unit 23 includes frame 234 that supports fixing plate 232 and holding plate 235 that supports movable plate 233. Further, blade unit 23 includes spring 2341 that is attached to frame 234 and presses movable plate 233 against fixing plate 232 to bring fixed blade 2321 and movable blade 2331 into contact with each other.

Fixing plate 232 and movable plate 233 are disposed to face each other in the front-rear direction. Frame 234 supports fixing plate 232 from the rear side (that is, from the side opposite to the side where movable plate 233 is disposed with respect to fixing plate 232). This prevents fixing plate 232 to be displaced positionally. In addition, holding plate 235 supports movable plate 233 from the front side (that is, from the side opposite to the side where fixing plate 232 is disposed with respect to movable plate 233). This prevents movable plate 233 to be displaced positionally.

As spring 2341 that brings fixed blade 2321 and movable blade 2331 into contact with each other, for example, a torsion spring may be used, and the torsion spring (that is, spring 2341) is attached to frame 234.

Holding plate 235 is provided with connection part 2351, and link 2443 of the conversion mechanism 244 is linked to connection part 2351 in a state where blade unit 23 is attached to head body 21. With this configuration, when rotary motor 15 is driven, only the force in the width direction of blade unit 23 is transmitted from link 2443 to connection part 2351, and movable plate 233 reciprocates in the width direction of blade unit 23 via holding plate 235. Then, movable blades 2331 reciprocally slide with respect to fixed blades 2321, and thus, hair H (that is, an example of body hair) is cut between movable blades 2331 and fixed blades 2321.

In the present exemplary embodiment, attachment 3 for adjusting the length (more specifically, the length after cutting) of hair H (that is, an example of body hair) to be cut can be detachably attached to head 20. When such attachment 3 is attached to head 20, blade part 231, which is a functional part of head 20, is also protected by attachment 3.

### Example of Configuration of Attachment

Next, an example of a configuration of attachment 3 will be described.

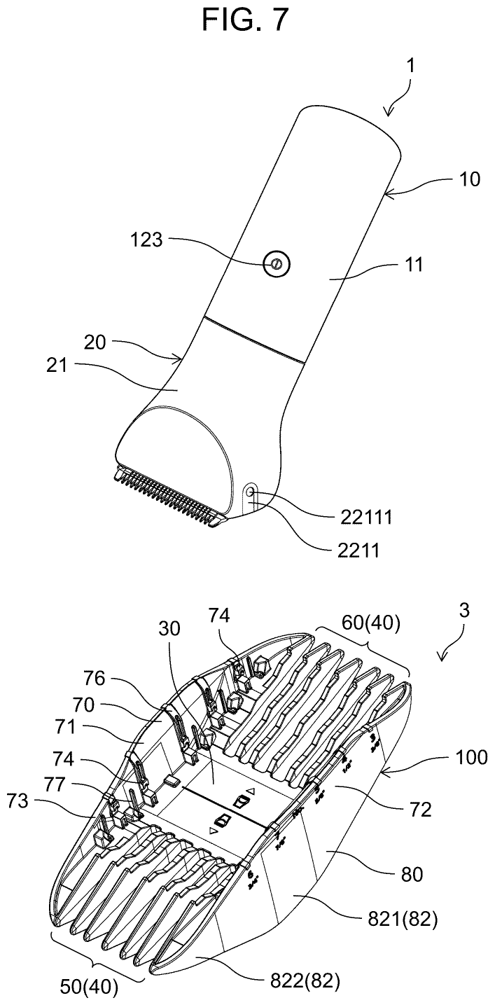

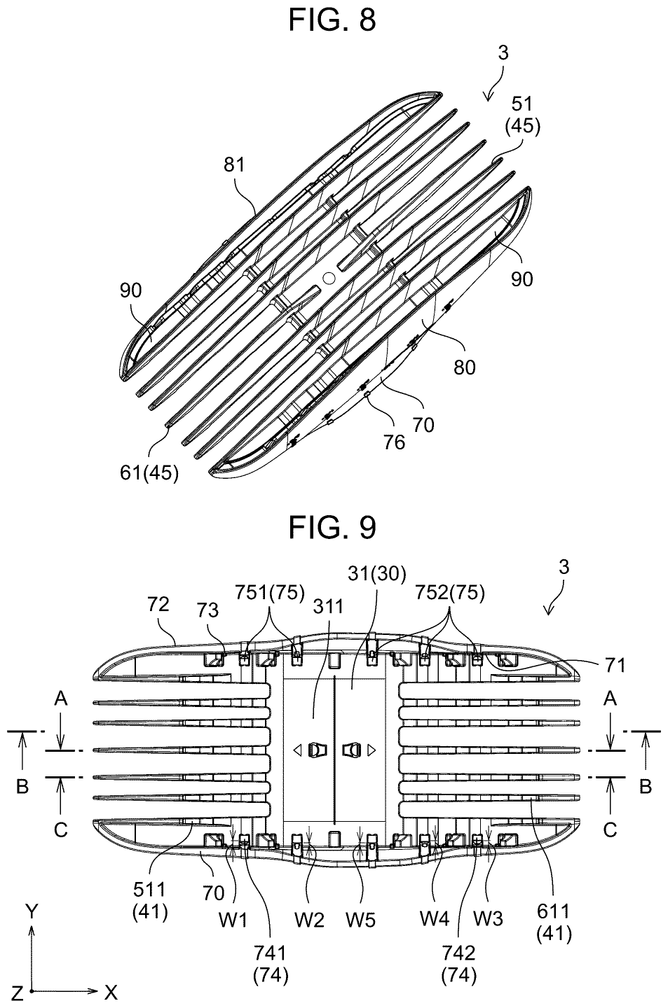

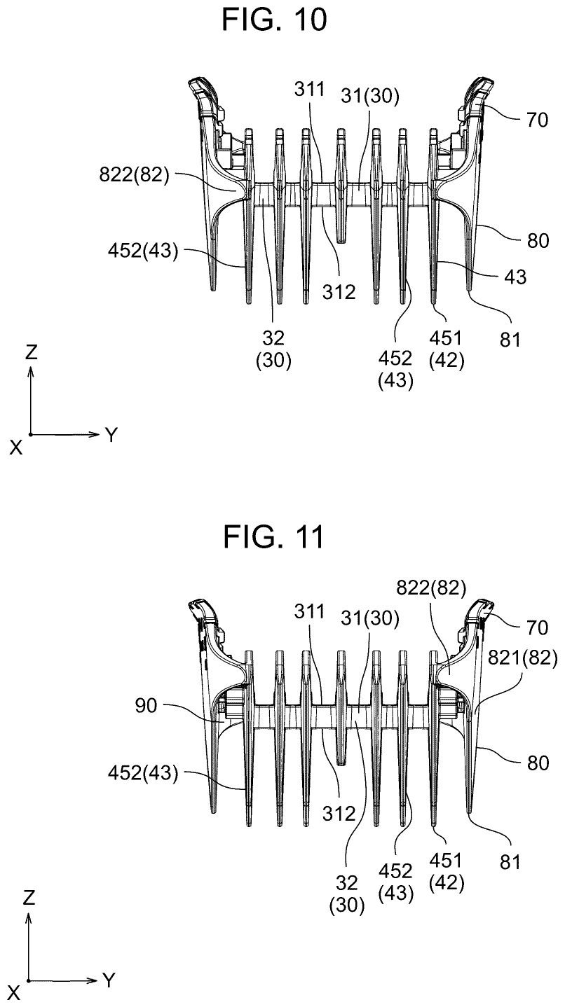

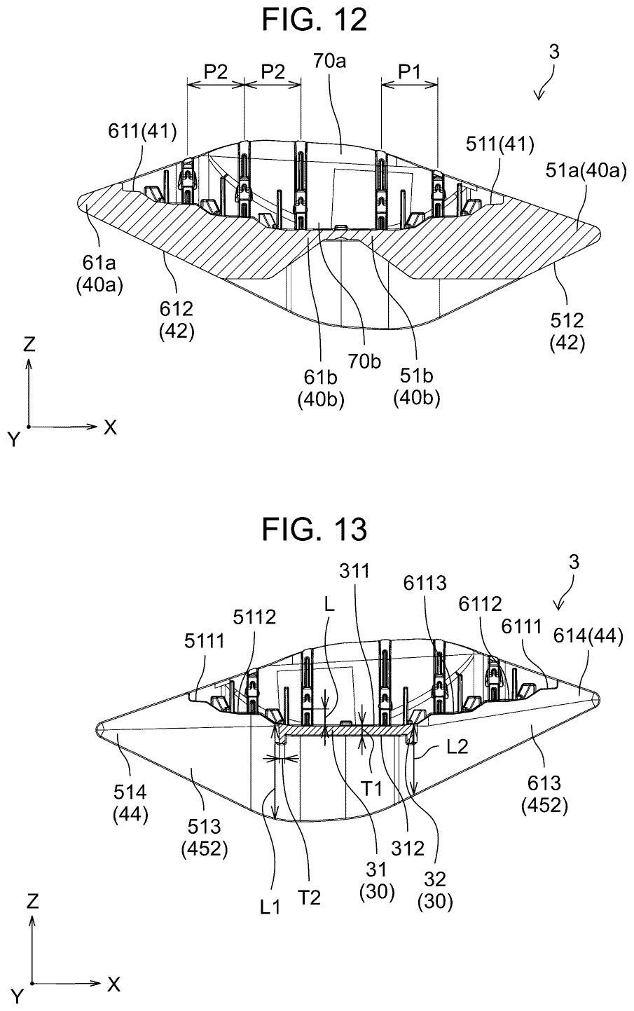

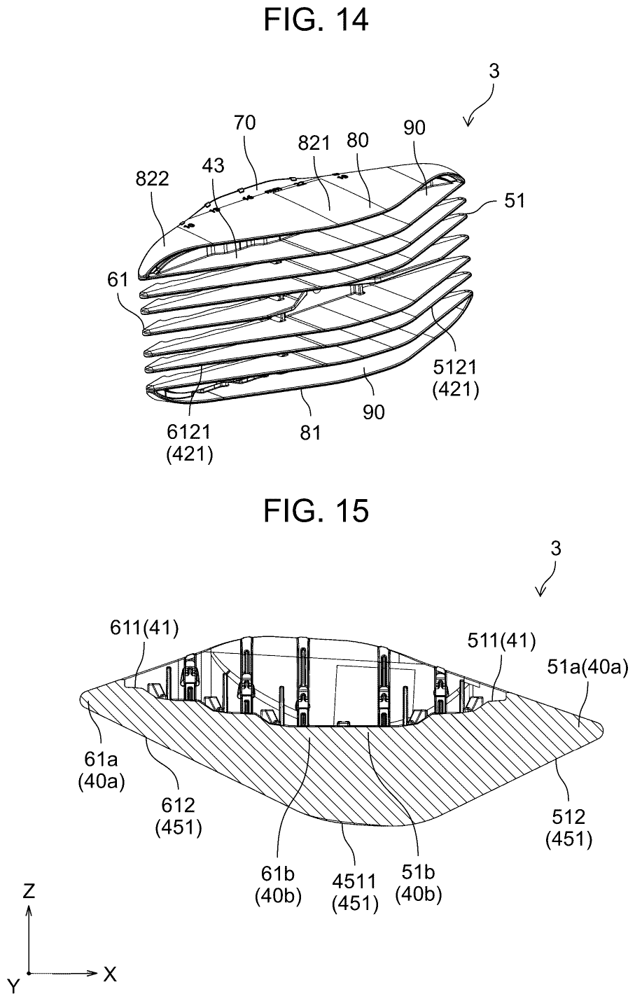

FIG. 7 is a perspective view schematically illustrating an example of the cutting device (for example, hair clipper 1) according to the exemplary embodiment and an example of attachment 3 in a state of not being attached to the cutting device (for example, hair clipper 1). FIG. 8 is a perspective view schematically illustrating a state in which an example of attachment 3 according to the exemplary embodiment is viewed from the rear surface thereof. FIG. 9 is a plan view schematically illustrating an example of attachment 3 according to the exemplary embodiment. FIG. 10 is a front view schematically illustrating an example of attachment 3 according to the exemplary embodiment. FIG. 11 is a rear view schematically illustrating an example of attachment 3 according to the exemplary embodiment. FIG. 12 is a sectional view taken along line A-A in FIG. 9. FIG. 13 is a sectional view taken along line B-B in FIG. 9. FIG. 14 is a perspective view schematically illustrating skin contact surface 42 of comb part 40 as an example of attachment 3 according to the exemplary embodiment. FIG. 15 is a sectional view taken along line C-C in FIG. 9. As illustrated in FIGS. 7 to 14, attachment 3 according to the present exemplary embodiment includes base plate 30 (that is, an example of the base) which has a shape of a substantially rectangular plate and extends in substantially horizontal direction, comb part 40 provided on base plate 30 (that is, an example of the base) and projecting in the X direction (that is, the front-rear direction and the second direction), and a pair of sandwiching walls 70 provided on base plate 30 (that is, an example of the base) and configured to sandwich hair clipper 1 from both sides in the Y direction (that is, the width direction and the third direction).

Comb part 40 has a function of guiding hair H (that is, an example of body hair) to blade part 231 while regulating hair H, and as illustrated in FIG. 8, has a plurality of combs 45 arranged side by side in a state of being separated in the Y direction (that is, the width direction and the third direction).

In the present exemplary embodiment, each comb 45 has a substantially plate shape, and as illustrated in FIGS. 9 to 11, each comb 45 is formed continuously with base plate 30 (that is, an example of the base) in a state where each comb 45 extends in the X direction (that is, the width direction and the third direction) and where while each comb 45 has a plate thickness direction which corresponds substantially to the Y direction (that is, the front-rear direction and the second direction).

With this configuration, when hair H (that is, an example of body hair) is cut using comb part 40, hair H (that is, an example of body hair) can be introduced into a space formed between combs 45 adjacent to each other, and the introduced hair H (that is, an example of body hair) is guided to blade part 231 while being regulated. Guided hair H (that is, an example of body hair) is cut by blade part 231.

As illustrated in FIG. 12, comb part 40 includes facing surface 41 that is positioned on one side (more specifically, the upper side) in the Z direction (that is, the up-down direction and the first direction) and can face blade part 231, and skin contact surface 42 that is positioned on the other side (more specifically, the lower side) in the Z direction (that is, the up-down direction and the first direction) and can contact skin S. Further, comb part 40 includes a pair of side surfaces 43 that links facing surface 41 and skin contact surface 42 on both sides in the Y direction (that is, the width direction and the third direction).

In the present exemplary embodiment, as illustrated in FIG. 13, when viewed in the Y direction (that is, the width direction and the third direction), comb part 40 has tapered part 44 that tapers from root 40b positioned close to base plate 30 (that is, an example of the base) toward tip 40a. That is, comb part 40 has a shape in which the distance from skin contact surface 42 to facing surface 41 gradually decreases (more specifically, the shape in which facing surface 41 gradually approaches skin contact surface 42) from root 40b toward tip 40a.

As above, since comb part 40 has tapered part 44, the cutting height can be changed by shifting the facing position of blade part 231 with respect to facing surface 41 in the X direction (that is, the front-rear direction and the second direction).

In the present exemplary embodiment, the pair of sandwiching walls 70 are formed to rise from both sides of base plate 30 (that is, an example of the base) in the Y direction (that is, the width direction and the third direction) toward one side (more specifically, the upper side) in the Z direction (that is, the up-down direction and the first direction). Comb part 40 is formed inside of the pair of sandwiching walls 70 in the Y direction (that is, the width direction and the third direction) so as to extend from base plate 30 (that is, an example of the base) toward the other side (more specifically, the lower side) in the Z direction (that is, the up-down direction and the first direction). With this configuration, a space opened to one side (more specifically, the upper side) in the Z direction (that is, the up-down direction and the first direction) is formed between the pair of sandwiching walls 70.

Head 20 of hair clipper 1 is introduced from above into the space formed between the pair of sandwiching walls 70, and thus head 20 of hair clipper 1 is held by the pair of sandwiching walls 70 from both sides in the Y direction (that is, the width direction and the third direction).

In the present exemplary embodiment, on each of inner surfaces 71 of the pair of sandwiching walls 70, an engagement projection 74 (that is, an example of an engagement part) is formed to project inward in the Y direction (that is, the width direction and the third direction). On both sides of head 20 of hair clipper 1 in the Y direction (that is, the width direction and the third direction), grooves 2211 are formed to open to attachment 3 side. In the inside of each groove 2211, engagement recess 22111 (that is, an example of an engaged part) with which engagement projection 74 (that is, an example of the engagement part) can be engaged is formed.

When head 20 of hair clipper 1 is introduced from above into the space formed between the pair of sandwiching walls 70, engagement projections 74 (that is, an example of engagement part) are introduced into grooves 2211 to be engaged with engagement recesses 22111 (that is, an example of the engaged part) formed in the inside of each groove 2211.

This allows attachment 3 to be attached to head 20 of hair clipper 1 in a state where the relative movement of attachment 3 is restricted, and the distance between blade part 231 and skin contact surface 42 can be maintained at a predetermined constant distance.

In this manner, in the present exemplary embodiment, attachment 3 is configured to be detachably attached to hair clipper 1 by moving the attachment 3 in the Z direction (that is, the up-down direction and the first direction) relative to hair clipper 1 to releasably engage engagement projections 74 (that is, an example of the engagement part) with engagement recesses 22111 (that is, an example of the engaged part). That is, attachment 3 according to the present exemplary embodiment is an attachment that can be detachably attached to hair clipper 1 by moving the attachment in the Z direction (that is, the up-down direction and the first direction) relative to hair clipper 1 having blade part 231.

In the present exemplary embodiment, by moving attachment 3 in the Z direction (that is, the up-down direction and the first direction) relative to hair clipper 1, engagement projections 74 (that is, an example of the engagement part) can be engaged with engagement recesses 22111 (that is, an example of the engaged part), and engagement between engagement projection 74 (that is, an example of the engagement part) and engagement recesses 22111 (that is, an example of the engaged part) can be released.

Attachment 3 having such a configuration is attached to head 20 of hair clipper 1, and skin contact surface 42 of attachment 3 is brought into contact with skin S so as to slide on skin S, whereby hair H (that is, an example of body hair) introduced into the space formed between adjacent combs 45 is guided to blade part 231 while being regulated by combs 45. When hair H (that is, an example of body hair) guided by blade part 231 is cut by blade part 231, hair H (that is, an example of body hair) is cut to a desired uniform length (as an example, the distance between blade part 231 and skin contact surface 42 in a state where attachment 3 is attached to head 20).

At this time, in the present exemplary embodiment, attachment 3 is attached to head 20 of hair clipper 1 in a state where movement (as an example, slide) of attachment 3 in the X direction (that is, the front-rear direction and the second direction) is restricted. Thus, when hair clipper 1 to which attachment 3 has been attached is used, attachment 3 can be more reliably prevented from unintentionally moving in the X direction (that is, the front-rear direction and the second direction), which is the direction in which the cutting height is changed. As a result, when hair H (that is, an example of body hair) is cut to a predetermined cutting height, variation in the cutting height is suppressed, and hair H (that is, an example of body hair) can be more reliably cut to a desired uniform length.

In the present exemplary embodiment, comb part 40 includes first comb part 50 formed to project from base plate 30 (that is, an example of the base) in the front direction of the X direction (that is, the front-rear direction and the second direction), and second comb part 60 formed to project from base plate 30 (that is, an example of the base) in the rear direction of the X direction (that is, the front-rear direction and the second direction).

Each of first comb part 50 and second comb part 60 has a function of guiding hair H (that is, an example of body hair) to blade part 231 while regulating hair H.

Specifically, first comb part 50 includes a plurality of first combs 51 arranged side by side in a state of being separated in the Y direction (that is, the width direction and the third direction).

In the present exemplary embodiment, each first comb 51 has a substantially plate shape, and is formed continuously with one side (more specifically, the front side) of base plate 30 (that is, an example of the base) in the X direction (that is, the front-rear direction and the second direction) in a state of projecting in the front direction of the X direction (that is, the front-rear direction and the second direction) in a state where the plate thickness direction substantially corresponds to the Y direction (that is, the width direction and the third direction).

With this configuration, when hair H (that is, an example of body hair) is cut using first comb part 50, hair H (that is, an example of body hair) can be introduced into a space formed between first combs 51 adjacent to each other, and introduced hair H (that is, an example of body hair) is guided to blade part 231 while being regulated. Guided hair H (that is, an example of body hair) is cut by blade part 231.

Each first comb 51 is formed with first facing surface 511 that is positioned on one side (more specifically, the upper side) in the Z direction (that is, the up-down direction and the first direction) and can face blade part 231, and first skin contact surface 512 that is positioned on the other side (more specifically, the lower side) in the Z direction (that is, the up-down direction and the first direction) and can contact skin S. Further, each first comb 51 is formed with a pair of first side surfaces 513 that link first facing surface 511 and first skin contact surface 512 on both sides in the Y direction (that is, the width direction and the third direction).

In the present exemplary embodiment, each first comb 51 has first tapered part 514 that tapers from first root 51b positioned close to base plate 30 (that is, an example of the base) toward first tip 51a as viewed along the Y direction (that is, the width direction and the third direction). That is, each first comb 51 has a shape in which the distance from first skin contact surface 512 to first facing surface 511 gradually decreases (more specifically, a shape in which first facing surface 511 gradually approaches first skin contact surface 512) from first root 51b toward first tip 51a.

As above, since each first comb 51 has first tapered part 514 like this, the cutting height can be changed by shifting the facing position of blade part 231 with respect to first facing surface 511 in the X direction (that is, the front-rear direction and the second direction).

Similarly, second comb part 60 include a plurality of second combs 61 arranged side by side in a state of being separated in the Y direction (that is, the width direction and the third direction).

Specifically, second comb part 60 includes a plurality of second combs 61 arranged side by side in the state of being separated in the Y direction (that is, the width direction and the third direction).

In the present exemplary embodiment, each second combs 61 has a substantially plate shape, and is formed continuously with the other side (more specifically, the rear side) in the X direction (that is, the front-rear direction and the second direction) of base plate 30 (that is, an example of the base) in a state of projecting in the rear direction of the X direction (that is, the front-rear direction and the second direction) in a state where the plate thickness direction substantially corresponds to the Y direction (that is, the width direction and the third direction).

With this configuration, when hair H (that is, an example of body hair) is cut using second comb part 60, hair H (that is, an example of body hair) can be introduced into a space formed between second combs 61 adjacent to each other, and introduced hair H (that is, an example of body hair) is guided to blade part 231 while being regulated. Guided hair H (that is, an example of body hair) is cut by blade part 231.

Each second comb 61 is formed with second facing surface 611 that is positioned on one side (more specifically, the upper side) in the Z direction (that is, the up-down direction and the first direction) and can face blade part 231, and second skin contact surface 612 that is positioned on the other side (more specifically, the lower side) in the Z direction (that is, the up-down direction and the first direction) and can contact skin S. Further, each second comb 61 is formed with a pair of second side surfaces 613 that link second facing surface 611 and second skin contact surface 612 on both sides in the Y direction (that is, the width direction and the third direction).

In the present exemplary embodiment, each second comb 61 has second tapered part 614 that tapers from second root 61b positioned close to base plate 30 (that is, an example of the base) toward second tip 61a as viewed along the Y direction (that is, the width direction and the third direction). That is, each second comb 61 has a shape in which the distance from second skin contact surface 612 to second facing surface 611 gradually decreases (more specifically, a shape in which second facing surface 611 gradually approaches second skin contact surface 612) from second root 61b toward second tip 61a.

As above, since each second comb 61 has second tapered part 614, the cutting height can be changed by shifting the facing position of blade part 231 with respect to second facing surface 611 in the X direction (that is, the front-rear direction and the second direction).

Thus, in the present exemplary embodiment, first facing surface 511 formed on each first comb 51 and second facing surface 611 formed on each second comb 61 are formed on comb part 40 to be positioned on one side (more specifically, the upper side) in the Z direction (that is, the up-down direction and the first direction), and the facing surfaces form facing surfaces 41 configured to face blade part 231.

First skin contact surface 512 formed on each first comb 51 and second skin contact surface 612 formed on each second comb 61 are formed on comb part 40 to be positioned on the other side (more specifically, the lower side) in the Z direction (that is, the up-down direction and the first direction). First skin contact surface 512 and second skin contact surface 612 form skin contact surface 42 configured to come into contact with skin S.

First side surface 513 on the outer side of first comb 51 positioned on the outermost side in the Y direction (that is, the width direction and the third direction) and second side surface 613 on the outer side of second comb 61 positioned on the outermost side in the Y direction (that is, the width direction and the third direction) are a pair of side surfaces 43 of comb part 40 formed to link facing surface 41 and skin contact surface 42 on both sides in the Y direction (that is, the width direction and the third direction).

Further, in the present exemplary embodiment, first tapered part 514 formed in each first comb 51 and second tapered part 614 formed in each second comb 61 form tapered part 44 of comb part 40 that tapers from root 40b positioned close to base plate 30 (that is, an example of the base) toward tip 40a as viewed along the Y direction (that is, the width direction and the third direction).

In the present exemplary embodiment, the number of first combs 51 is equal to the number of second combs 61. More specifically, the number of first combs 51 and the number of second combs 61 are equal to 7. First comb 51 and second comb 61 corresponding to each other are disposed at the same position in the Y direction (that is, the width direction and the third direction). That is, first comb 51 and second comb 61 corresponding to each other are formed to be positioned on the same straight line in the X direction (that is, the front-rear direction and the second direction). Thus, in the present exemplary embodiment, first comb 51 and second comb 61 linked to each other constitute one comb 45.

However, when comb part 40 includes first comb part 50 and second comb part 60, it is not necessary to have the above-described configuration, and the number of first combs 51 and the number of second combs 61 can be made different from each other. The number of first combs 51 may be equal to the number of second combs 61, and first comb 51 and second comb 61 corresponding to each other may be shifted in the Y direction (that is, the width direction and the third direction).

Further, in the present exemplary embodiment, engagement projections 74 (that is, an example of the engagement part) include first engagement projection 741 (that is, an example of a first engagement part) to be engaged with engagement recess 22111 (that is, an example of the engaged part) when first comb part 50 is used, and second engagement projection 742 (that is, an example of a second engagement part) to be engaged with engagement recess 22111 (that is, an example of the engaged part) when second comb part 60 is used. First engagement projection 741 (that is, an example of the first engagement part) and second engagement projection 742 (that is, an example of the second engagement part) are arranged side by side in a state of being separated in the X direction (that is, the front-rear direction and the second direction). Specifically, the first engagement projection 741 (that is, an example of the first engagement part) is formed at the front portion of the pair of sandwiching walls 70 in the X direction (that is, the front-rear direction and the second direction), and second engagement projection 742 (that is, an example of the second engagement part) is formed at the rear portion of the pair of sandwiching walls 70 in the X direction (that is, the front-rear direction and the second direction). In this manner, in the present exemplary embodiment, a plurality of engagement projections 74 (that is, an example of the engagement parts) that can be releasably engaged with engagement recesses 22111 (that is, an example of the engaged part) formed on hair clipper 1 by relatively moving engagement projections 74 in the Z direction (that is, the up-down direction and the first direction) are provided in the pair of sandwiching walls 70 in a state of being separated from each other in the X direction (that is, the front-rear direction and the second direction).

When first engagement projection 741 (that is, an example of the first engagement part) is engaged with engagement recess 22111 (that is, an example of the engaged part), head 20 of hair clipper 1 is introduced from above into the space formed between the pair of sandwiching walls 70 in a state where the tip of blade part 231 faces one direction (more specifically, the front direction) of the X direction (that is, the front-rear direction and the second direction).

On the other hand, when second engagement projection 742 (that is, an example of the second engagement part) is engaged with engagement recess 22111 (that is, an example of the engaged part), head 20 of hair clipper 1 is introduced from above into the space formed between the pair of sandwiching walls 70 in a state where the tip of blade part 231 faces the other direction (more specifically, the rear direction) of the X direction (that is, the front-rear direction and the second direction).

In this manner, in the present exemplary embodiment, attachment 3 includes first comb part 50 and second comb part 60, and when hair clipper 1 is attached to attachment 3, the orientation of blade part 231 can be changed. By changing the orientation of the blade part 231, it is possible to select which comb of first comb part 50 or second comb part 60 is to be used. This allows the cutting height to be adjusted in each comb part, and variations of the cutting height can be further increased.

In the present exemplary embodiment, the cutting height when first comb part 50 is used and the cutting height when second comb part 60 is used are different from each other. With this configuration, the cutting height can be selectively changed by engaging one engagement part selected from a plurality of engagement parts (more specifically, first engagement projection 741 and second engagement projection 742) arranged side by side in a state of being separated in the X direction (that is, the front-rear direction and the second direction) with engagement recess 22111 (that is, an example of the engaged part).

Specifically, as illustrated in FIG. 13, length L1 of one side of first comb part 50 close to the base plate 30 (that is, an example of the base) in the Z direction (that is, the up-down direction and the first direction) is different from length L2 of one side of second comb part 60 close to the base plate 30 (that is, an example of the base) in the Z direction (that is, the up-down direction and the first direction). In the present exemplary embodiment, length L2 is shorter than length L1. That is, the thickness of the one side of second comb part 60 close to base plate 30 (that is, an example of the base) is made thinner than the thickness of the one side of first comb part 50 close to base plate 30 (that is, an example of the base). This allows the cutting height in the case of using first comb part 50 and the cutting height in the case of using second comb part 60 to be set to different values more easily.

When length L1 of the one side of first comb part 50 in the Z direction (that is, the up-down direction and the first direction) close to base plate 30 (that is, an example of the base) is made different from length L2 of the one side of second comb part 60 in the Z direction (that is, the up-down direction and the first direction) close to base plate 30 (that is, an example of the base), the shape of first comb part 50 is different from the shape of second comb part 60. Thus, first comb part 50 and second comb part 60 can be easily distinguished. Thus, when attachment 3 is attached to head 20 of hair clipper 1, a comb part desired to be used can be more easily distinguished, and the usability of attachment 3 can further improve.

Further, in the present embodiment, as illustrated in FIG. 9, engagement projection 74 (that is, an example of the engagement part) includes selective engagement group 75. Here, selective engagement group 75 is a group (that is, assembly) of engagement parts configured by two or more engagement projections 74 (that is, an example of the engagement part) configured to selectively engage with the engagement recess 22111 (that is, an example of the engaged part) in a state where hair clipper 1 is disposed in such a manner that blade part 231 faces the same direction (i.e., under a requirement that the attachment is attached to the cutting device without changing a direction in which the blade part projects with respect to the attachment and configured to change the distance (that is, the cutting height) from skin contact surface 42 to blade part 231 in a state where engagement projections 74 are engaged with engagement recesses 22111 (that is, an example of the engaged part).

That is, attachment 3 includes selective engagement group 75 constituted by two or more engagement projections 74 (that is, an example of the engagement part) that can be selectively engaged with engagement recesses 22111 (that is, an example of the engaged part) in a state where hair clipper 1 is disposed in such a manner that blade part 231 faces the same direction (i.e., under the requirement that the attachment is attached to the cutting device without changing the direction in which the blade part projects with respect to the attachment. In selective engagement group 75, there is at least one engagement projection 74 (that is, an example of the engagement part) configured to change the distance (that is, the cutting height) from skin contact surface 42 to blade part 231 in a state where the at least one engagement projection 74 is engaged with engagement recess 22111 (that is, an example of the engaged part).

In the present exemplary embodiment, there are two first engagement projections 741 (that is, an example of the first engagement part) used for using first comb part 50 as one comb part. There may be a plurality of first engagement projections 741 (that is, an example of the first engagement part), that is, at least two first engagement projections. Two first engagement projections 741 (that is, an example of the first engagement part) are arranged side by side at the front portion of the pair of sandwiching walls 70 in the X direction (that is, the front-rear direction and the second direction) in a state of being separated from each other in the X direction (that is, the front-rear direction and the second direction) at first pitch P1. With this configuration, head 20 of hair clipper 1 in a state where the tip of blade part 231 faces one side (more specifically, the front side) in the X direction (that is, the front-rear direction and the second direction) can be attached to attachment 3 by shifting the head in the X direction (that is, the front-rear direction and the second direction). That is, the relative position of head 20 of hair clipper 1 with respect to attachment 3 in a state where one first engagement projection 741 (that is, an example of the first engagement part) is engaged with engagement recess 22111 (that is, an example of the engaged part) and the relative position of head 20 of hair clipper 1 with respect to attachment 3 in a state where the other first engagement projection 741 (that is, an example of the first engagement part) is engaged with engagement recess 22111 (that is, an example of the engaged part) are shifted by first pitch P1 in the X direction (that is, the front-rear direction and the second direction).

At this time, since first comb 51 of first comb part 50 has the shape having first tapered part 514, the cutting height is different between the case where one first engagement projection 741 (that is, an example of the first engagement part) is engaged with engagement recess 22111 (that is, an example of the engaged part) and the case where the other first engagement projection 741 (that is, an example of the first engagement part) is engaged with engagement recess 22111 (that is, an example of the engaged part).

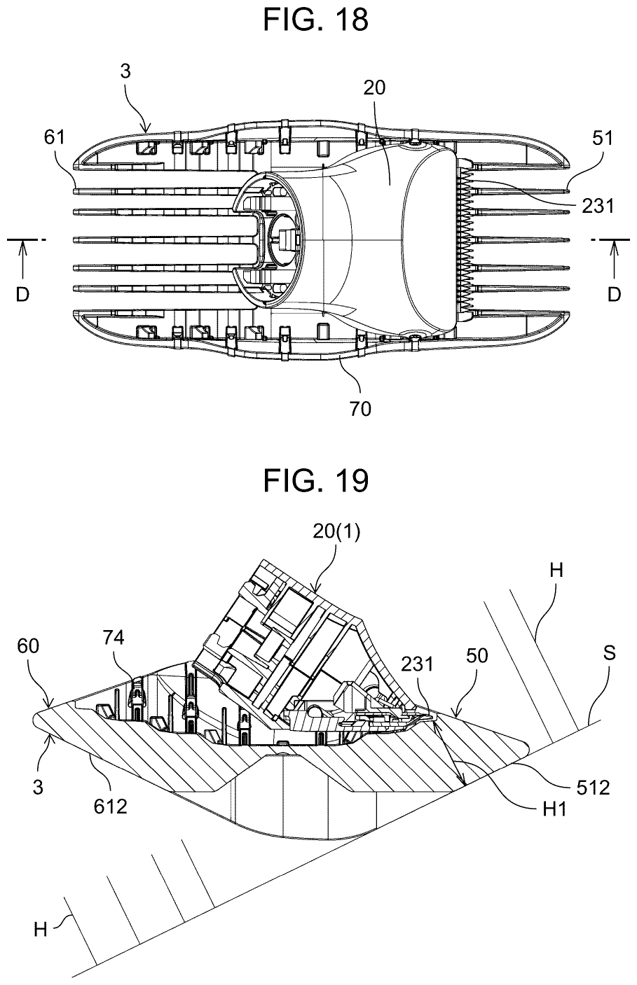

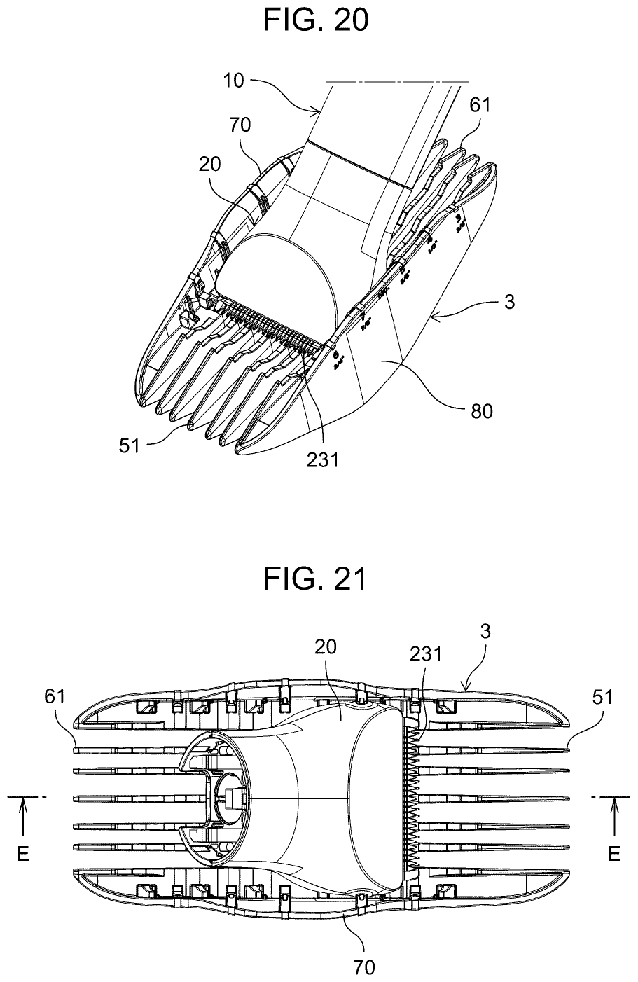

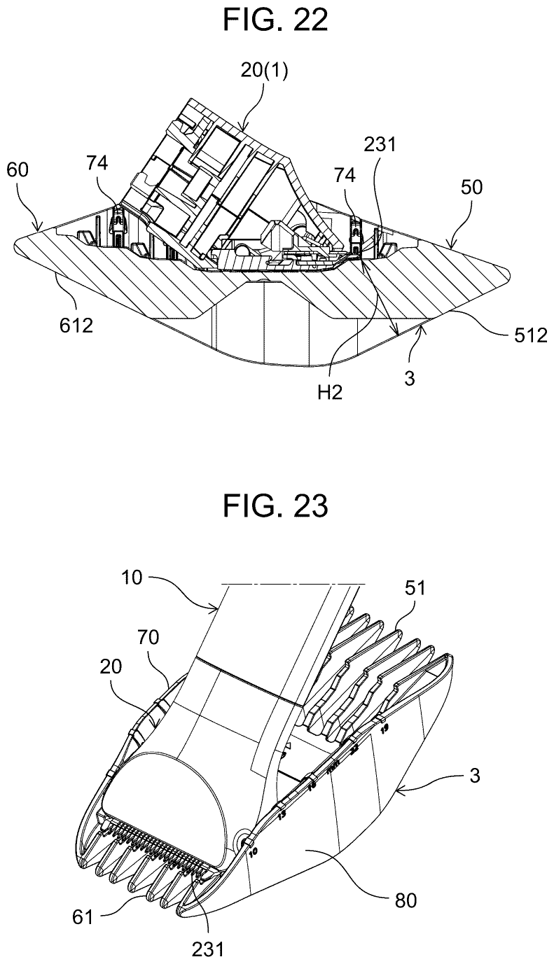

FIG. 17 is a perspective view schematically illustrating a state in which the engaged part (for example, engagement recess 22111) of the cutting device (for example, hair clipper 1) is engaged with the engagement part provided at the tip in first selective engagement group 751 provided in an example of attachment 3 according to the exemplary embodiment. FIG. 18 is a plan view schematically illustrating the state in which the engaged part (for example, engagement recess 22111) of the cutting device (for example, hair clipper 1) is engaged with the engagement part provided at the tip in first selective engagement group 751 provided in an example of attachment 3 according to the exemplary embodiment. FIG. 19 is a sectional view taken along line D-D in FIG. 18. FIG. 20 is a perspective view schematically illustrating a state in which the engaged part (for example, engagement recess 22111) of the cutting device (for example, hair clipper 1) is engaged with the engagement part provided close to the base (for example, base plate 30) in first selective engagement group 751 provided in an example of attachment 3 according to the exemplary embodiment. FIG. 21 is a plan view schematically illustrating the state in which the engaged part (for example, engagement recess 22111) of the cutting device (for example, hair clipper 1) is engaged with the engagement part provided close to the base (for example, base plate 30) in first selective engagement group 751 provided in an example of attachment 3 according to the exemplary embodiment. FIG. 22 is a sectional view taken along line E-E in FIG. 21. In the present exemplary embodiment, as illustrated in FIGS. 19 and 22, distance (cutting height) H2 from first skin contact surface 512 to blade part 231 in a case where first engagement projection 741 (that is, an example of the first engagement part) positioned close to first root 51b is engaged with engagement recess 22111 (that is, an example of the engaged part) is larger than distance (cutting height) H1 from first skin contact surface 512 to blade part 231 in a case where first engagement projection 741 (that is, an example of the first engagement part) positioned close to first tip 51a out of two first engagement projections 741 (that is, an example of the first engagement part) is engaged with engagement recess 22111 (that is, an example of the engaged part).

In this manner, in the present exemplary embodiment, selective engagement group 75 includes first selective engagement group 751 constituted by two or more first engagement projections 741 (that is, an example of the first engagement part) configured to selectively engage with engagement recess 22111 (that is, an example of the engaged part) in a state where hair clipper 1 is disposed in such a manner that blade part 231 faces one side (more specifically, the front side) in the X direction (that is, the front-rear direction and the second direction), and configured to change the distance from first skin contact surface 512 to blade part 231 in a state where first engagement projection 741 is engaged with engagement recesses 22111 (that is, an example of the engaged part).

Thus, attachment 3 according to the present exemplary embodiment is configured to set two or more types of cutting heights with respect to first comb part 50 which is one comb part by changing the place where head 20 of hair clipper 1 is attached. That is, attachment 3 is configured to selectively change the cutting height at first comb part 50 which is one comb part without sliding attachment 3 in the X direction (that is, the front-rear direction and the second direction) with respect to head 20 of hair clipper 1. As an example, attachment 3 according to the present exemplary embodiment is configured to set two types of cutting heights with respect to first comb part 50 which is one comb part by changing the place where head 20 of hair clipper 1 is attached.

At this time, attachment 3 is attached to head 20 of hair clipper 1 in a state where a movement (as an example, slide) of attachment 3 in the X direction (that is, the front-rear direction and the second direction) is restricted. Thus, when hair clipper 1 to which attachment 3 is attached is used in a state where a desired cutting height is set, attachment 3 can be more reliably prevented from unintentionally moving in the X direction (that is, the front-rear direction and the second direction), which is a direction in which the cutting height is changed. As a result, when hair H (that is, an example of body hair) is cut to a predetermined cutting height by using first comb part 50, variation in the cutting height is suppressed, and hair H (that is, an example of body hair) can be more reliably cut to a desired uniform length.

Further, in the present exemplary embodiment, there are a plurality of (that is, at least two) second engagement projections 742 (that is, an example of the second engagement part) used for using second comb part 60 as one comb part. As an example, in the present exemplary embodiment, there are three second engagement projection 742 (that is, an example of the second engagement part) used for using second comb part 60 as one comb part. As illustrated in FIG. 12, three second engagement projection 742 (that is, an example of the second engagement part) are arranged side by side at the rear portion of the pair of sandwiching walls 70 in the X direction (that is, the front-rear direction and the second direction) in a state of being separated at substantially equal intervals from each other in the X direction (that is, the front-rear direction and the second direction) at second pitch P2. Thus, head 20 of hair clipper 1 in a state where the tip of blade part 231 faces the other side (more specifically, the rear side) in the X direction (that is, the front-rear direction and the second direction) can be attached to attachment 3 by shifting the head in the X direction (that is, the front-rear direction and the second direction). That is, the relative position of head 20 of hair clipper 1 with respect to attachment 3 in a state where second engagement projection 742 (that is, an example of the second engagement part) at the tip side is engaged with engagement recess 22111 (that is, an example of the engaged part), the relative position of head 20 of hair clipper 1 with respect to attachment 3 in a state where second engagement projection 742 (that is, an example of the second engagement part) at the center is engaged with engagement recess 22111 (that is, an example of the engaged part), and the relative position of head 20 of hair clipper 1 with respect to attachment 3 in a state where second engagement projection 742 (that is, an example of the second engagement part) at the root is engaged with engagement recess 22111 (that is, an example of the engaged part) are shifted by second pitch P2 in the X direction (that is, the front-rear direction and the second direction).

At this time, since second comb 61 of second comb part 60 has a shape having second tapered part 614, the cutting height is different between the case where second engagement projection 742 (that is, an example of the second engagement part) at the tip is engaged with engagement recess 22111 (that is, an example of the engaged part), the case where second engagement projection 742 (that is, an example of the second engagement part) at the center is engaged with engagement recess 22111 (that is, an example of the engaged part), and the case where second engagement projection 742 (that is, an example of the second engagement part) at the root is engaged with engagement recess 22111 (that is, an example of the engaged part).

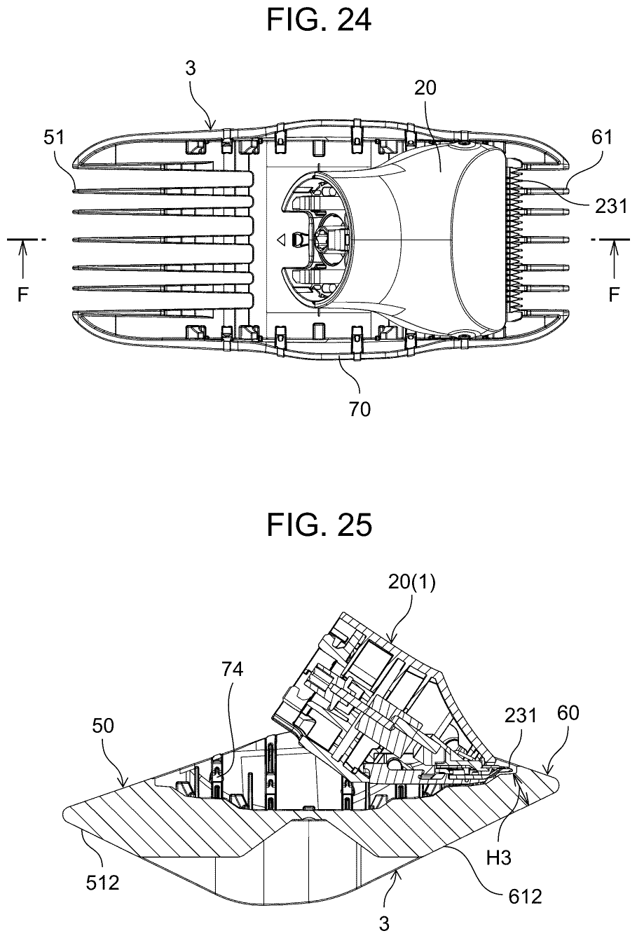

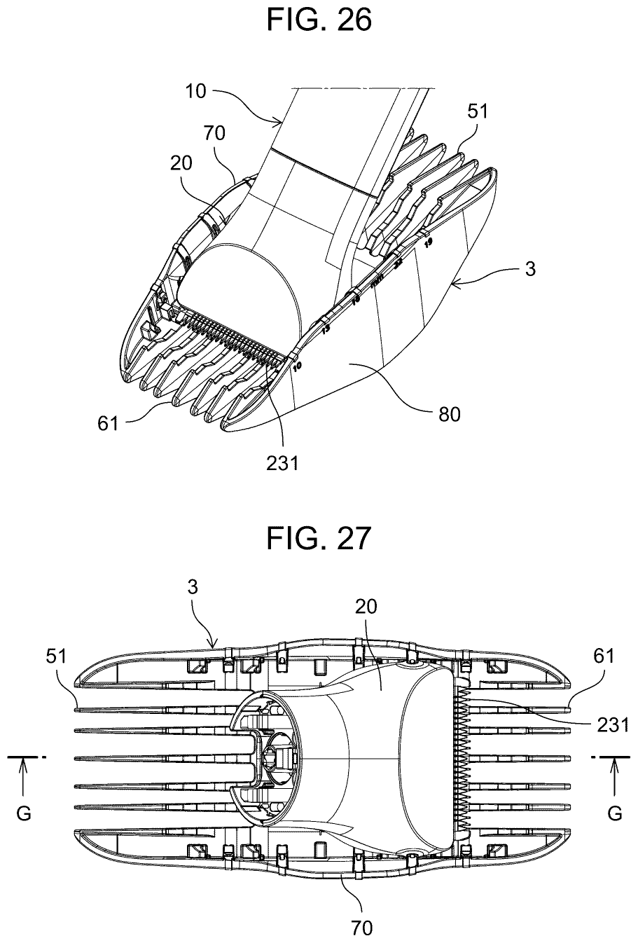

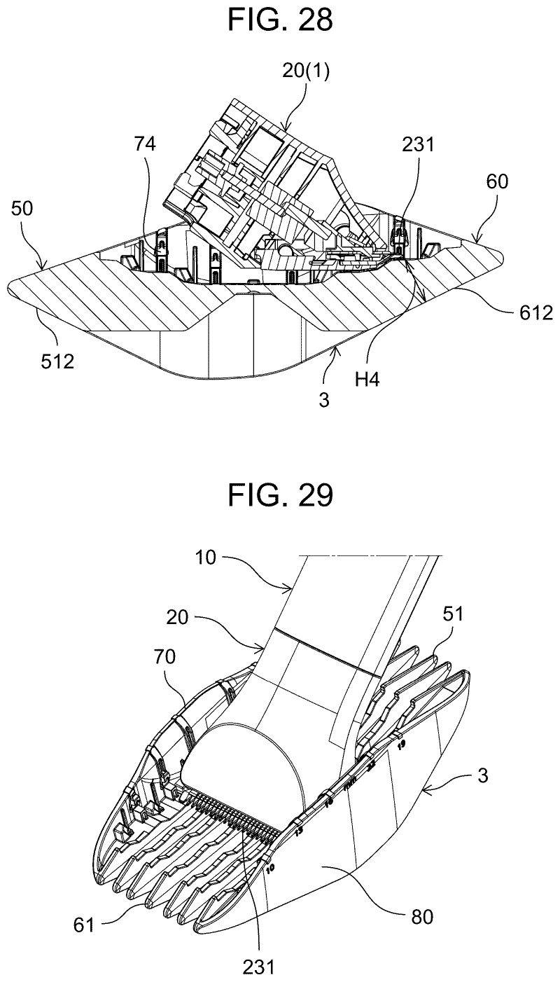

FIG. 23 is a perspective view schematically illustrating a state in which the engaged part (for example, engagement recess 22111) of the cutting device (for example, hair clipper 1) is engaged with the engagement part provided at the tip in second selective engagement group 752 provided in an example of attachment 3 according to the exemplary embodiment. FIG. 24 is a plan view schematically illustrating the state in which the engaged part (for example, engagement recess 22111) of the cutting device (for example, hair clipper 1) is engaged with the engagement part provided at the tip in second selective engagement group 752 provided in an example of attachment 3 according to the exemplary embodiment. FIG. 25 is a sectional view taken along line F-F in FIG. 24. FIG. 26 is a perspective view schematically illustrating a state in which the engaged part (for example, engagement recess 22111) of the cutting device (for example, hair clipper 1) is engaged with the engagement part provided at the center in second selective engagement group 752 provided in an example of attachment 3 according to the exemplary embodiment. FIG. 27 is a plan view schematically illustrating the state in which the engaged part (for example, engagement recess 22111) of the cutting device (for example, hair clipper 1) is engaged with the engagement part provided at the center in second selective engagement group 752 provided in an example of attachment 3 according to the exemplary embodiment. FIG. 28 is a sectional view taken along line G-G in FIG. 27. In the present exemplary embodiment, as illustrated in FIGS. 25 and 28, distance (cutting height) H4 from second skin contact surface 612 to blade part 231 in a case where second engagement projection 742 (that is, an example of the second engagement part) positioned at the center among the three second engagement projections 742 (that is, an example of the second engagement part) is engaged with engagement recess 22111 (that is, an example of the engaged part) is larger than distance (cutting height) H3 from second skin contact surface 612 to blade part 231 in a case where second engagement projection 742 (that is, an example of the second engagement part) positioned close to second tip 61a is engaged with engagement recess 22111 (that is, an example of the engaged part).

As illustrated in FIGS. 28 and 31, distance (cutting height) H5 from second skin contact surface 612 to blade part 231 in a case where second engagement projection 742 (that is, an example of the second engagement part) positioned at second root 61b out of the three second engagement projections 742 (that is, an example of the second engagement part) is engaged with engagement recess 22111 (that is, an example of the engaged part) is larger than distance (cutting height) H4 from second skin contact surface 612 to blade part 231 in a case where second engagement projection 742 (that is, an example of the second engagement part) positioned at the center is engaged with engagement recess 22111 (that is, an example of the engaged part).

In this manner, in the present exemplary embodiment, selective engagement group 75 includes second selective engagement group 752 constituted by two or more second engagement projection 742 (that is, an example of the second engagement part) configured to selectively engage with engagement recess 22111 (that is, an example of the engaged part) in a state where hair clipper 1 is disposed in such a manner that blade part 231 faces the other side (more specifically, the rear side) in the X direction (that is, the front-rear direction and the second direction), and configured to change the distance from second skin contact surface 612 to blade part 231 in a state where the second engagement projections 742 are engaged with engagement recesses 22111 (that is, an example of the engaged part).

Thus, attachment 3 according to the present exemplary embodiment is configured to set two or more types of cutting heights with respect to second comb part 60 which is one comb part by changing the place where head 20 of hair clipper 1 is attached. As an example, attachment 3 according to the present exemplary embodiment is configured to set three types of cutting heights with respect to second comb part 60 which is one comb part by changing the place where head 20 of hair clipper 1 is attached. That is, attachment 3 is configured to selectively change the cutting height at second comb part 60 which is one comb part without sliding attachment 3 in the X direction (that is, the front-rear direction and the second direction) with respect to head 20 of hair clipper 1.

At this time, attachment 3 is attached to head 20 of hair clipper 1 in a state where a movement (for example, slide) of attachment 3 in the X direction (that is, the front-rear direction and the second direction) is restricted. Thus, when hair clipper 1 to which attachment 3 is attached is used in a state where a desired cutting height is set, attachment 3 can be more reliably prevented from unintentionally moving in the X direction (that is, the front-rear direction and the second direction), which is a direction in which the cutting height is changed. As a result, when hair H (that is, an example of body hair) is cut to a predetermined cutting height by using second comb part 60, variation in the cutting height is suppressed, and hair H (that is, an example of body hair) can be more reliably cut to a desired uniform length.

In the present exemplary embodiment, the cutting height that can be realized when attachment 3 is used is shortened in the order of H2, H1, H5, H4, and H3, and the cutting height can be adjusted in five stages of H1 to H5 by using attachment 3.

In this manner, in the present exemplary embodiment, hair clipper 1 can be attached to attachment 3 by changing the orientation of blade part 231 (i.e., by changing a direction in which the blade part projects with respect the attachment), and at the same time, the cutting height of each comb part can be adjusted in multiple stages.

Further, in the present exemplary embodiment, all of the five engagement projections 74 (that is, an example of the engagement parts) are formed on the pair of sandwiching walls 70 such that distances L to facing surface 41 are substantially the same as each other. With this configuration, the distances from blade part 231 to facing surface 41 are substantially the same as each other even when engagement recess 22111 (that is, an example of the engaged part) is engaged with any one engagement projection 74 (that is, an example of the engagement part) out of five engagement projections 74 (that is, an example of the engagement part).

At this time, in the present exemplary embodiment, positions (more specifically, distances L) of five engagement projections 74 (that is, an example of the engagement parts) are set such that the gap between blade part 231 and facing surface 41 is minimized.

Specifically, first facing surface 511 is formed with tip step part 5111 and root step part 5112. When engagement recess 22111 (that is, an example of the engaged part) is engaged with first engagement projection 741 (that is, an example of the first engagement part) positioned close to first tip 51a, blade part 231 is placed on tip step part 5111. When engagement recess 22111 (that is, an example of the engaged part) is engaged with first engagement projection 741 (that is, an example of the first engagement part) positioned close to first root 51b, blade part 231 is placed on root step part 5112.

Similarly, tip step part 6111, center step part 6112, and root step part 6113 are formed on second facing surface 611. When engagement recess 22111 (that is, an example of the engaged part) is engaged with second engagement projection 742 (that is, an example of the second engagement part) positioned close to second tip 61a, blade part 231 is placed on tip step part 6111. When engagement recess 22111 (that is, an example of the engaged part) is engaged with second engagement projection 742 (that is, an example of the second engagement part) positioned at the center, blade part 231 is placed on center step part 6112. When engagement recess 22111 (that is, an example of the engaged part) is engaged with second engagement projection 742 (that is, an example of the second engagement part) positioned close to second root 61b, blade part 231 is placed on root step part 6113.

Thus, by minimizing the gap between blade part 231 and facing surface 41, hair waste can be more reliably prevented from entering the gap between blade part 231 and facing surface 41 at the time of cutting hair H (that is, one example of body hair). When hair waste is prevented from entering the gap between blade part 231 and facing surface 41, cutting performance of hair clipper 1 to cut hair H (that is, an example of body hair) can be prevented from deteriorating, and it is possible to more efficiently and accurately cut hair H (that is, an example of body hair).

Since all of five engagement projections 74 (that is, an example of the engagement part) are formed on the pair of sandwiching walls 70 such that distances L to facing surface 41 are substantially the same as each other in the present exemplary embodiment, engagement projections 74 (that is, an example of the engagement part) are formed at various height positions (more specifically, the positions in the first direction) of the pair of sandwiching walls 70. That is, in the pair of sandwiching walls 70, engagement projections 74 (shat is, an example of the base) formed at different height positions are present, such as engagement projection 74 (that is, an example of the engagement part) formed close to tip 70a at a position away from base plate 30 (that is, an example of the base) and engagement projection 74 (that is, an example of the engagement part) formed close to root 70b at a position close to base plate 30 (that is, an example of the engagement part).

Tip 70a of each of the pair of sandwiching walls 70 is a portion having a relatively large deflection amount when attachment 3 is attached to and detached from hair clipper 1, and root 70b of each of the pair of sandwiching walls 70 is a portion having a relatively small deflection amount when attachment 3 is attached to and detached from hair clipper 1.

Thus, when projection amounts WI to W5 of five engagement projections 74 (that is, an example of the engagement part) from inner surface 71 of each of the pair of sandwiching walls 70 are set to the same projection amount as each other, a force required at the time of attaching and detaching attachment 3 varies depending on the position where hair clipper 1 is attached.

In the present exemplary embodiment, projection amounts WI to W5 of five engagement projections 74 (that is, an example of the engagement part) from inner surface 71 of each of the pair of sandwiching walls 70 are made different based on the distance from base plate 30 (that is, an example of the base). That is, each of the projection amounts from inner surface 71 of each of the pair of sandwiching walls 70 is set in accordance with the portion of each of the pair of sandwiching walls 70 where engagement projection 74 (that is, an example of the engagement part) is formed.

Specifically, as illustrated in FIGS. 9 and 12, the projection amount of engagement projection 74 (that is, an example of the engagement part) formed close to root 70b of each of the pair of sandwiching walls 70, which is a portion where the deflection amount when attachment 3 is attached to and detached from hair clipper 1 is relatively small, is made small, whereas the projection amount of engagement projection 74 (that is, an example of the engagement part) formed close to tip 70a of each of the pair of sandwiching walls 70, which is a portion where the deflection amount is relatively large, is made large.

This allows the force required for attaching and detaching attachment 3 to be made more uniform.

In the present exemplary embodiment, as illustrated in FIG. 7, the pair of sandwiching walls 70 is formed with continuous projection 76 that is formed continuously with engagement projection 74 (that is, an example of the engagement part). Continuous projection 76 is continuously formed with outer surface 72 through end surface 73 on one side (more specifically, the upper side) of one of the pair of sandwiching walls 70 in the Z direction (that is, the up-down direction and the first direction). In this manner, in the present exemplary embodiment, continuous projection 76 is provided to extend to at least end surface 73 on one side (more specifically, the upper side) in the Z direction (that is, the up-down direction and the first direction) of the pair of sandwiching walls 70.

With this configuration, the position of engagement projection 74 (that is, an example of the engagement part) to be engaged when the cutting height is set to a desired cutting height can be more easily confirmed visually, and attachment workability of attachment 3 on hair clipper 1 can further improve.

When continuous projection 76 formed continuously with engagement projection 74 (that is, an example of the engagement part) is formed up to end surface 73 on one side (more specifically, the upper side) in the Z direction (that is, the up-down direction and the first direction) of the pair of sandwiching walls 70, continuous projection 76 can also function as a guide when engagement recess 22111 (that is, an example of the engaged part) of hair clipper 1 is engaged with engagement projection 74 (that is, an example of the engagement part).

Further, in the present exemplary embodiment, as illustrated in FIG. 7, rib 77 which interferes with hair clipper 1 when hair clipper 1 is positioned at a non-normal position is formed on inner surface 71 of the pair of sandwiching walls 70.

This configuration prevents attachment 3 from being erroneously attached to hair clipper 1. With this configuration, hair clipper 1 can be more reliably prevented from being attached to attachment 3 in a non-normal state (for example, a state in which blade part 231 is inclined obliquely with respect to attachment 3 and a state in which the direction of the blade is reversed).

Attachment 3 according to the present exemplary embodiment is resin molded article 100 integrally formed using an insulating synthetic resin material.

As above, when attachment 3 is resin molded article 100, it is preferable to increase the thickness of comb part 40 to secure the strength of combs 45.

However, when attachment 3 is formed using a synthetic resin material, as thickness of combs 45 is increased, the degree of difficulty in molding comb part 40 becomes higher. In addition, when the thickness of combs 45 is increased, there is a possibility that warpage occurs at the time of producing resin molded article 100.

In the present exemplary embodiment, occurrence of warpage can be more reliably suppressed even when the thickness of combs 45 is increased.

Specifically, as illustrated in FIG. 13, base plate 30 (that is, an example of the base) includes base body 31 and a pair of thin plates 32. Base body 31 has a substantially plate shape. Base body 31 includes upper surface 311 and lower surface 312. Base body extends in substantially horizontal direction in a state where plate thickness T1 substantially corresponds to the Z direction (that is, the up-down direction and the first direction). Pair of thin plates 32 (that is, an example of an intersection wall) respectively formed continuously from both ends in the X direction (that is, the front-rear direction and the second direction) of base body 31 and extending in substantially vertical direction in a state where plate thickness T2 substantially corresponds to the X direction (that is, the front-rear direction and the second direction) which is direction intersecting with the extending direction of base body 31. In this manner, in the present exemplary embodiment, plate thickness T2 of the pair of thin plates 32 (that is, an example of the intersection wall) is a thickness in the X direction (that is, the front-rear direction and the second direction). Plate thickness T1 of base body 31 is a thickness in the Z direction (that is, the up-down direction and the first direction).

In the present exemplary embodiment, the pair of thin plates 32 (that is, an example of the intersection wall) is formed in a state of projecting downward from lower surface 312 of base body 31. All combs 45 are linked by thin plate 32 (that is, an example of the intersection wall). In this manner, in the present exemplary embodiment, at least one thin wall 32 (that is, an example of the intersection wall) extending in direction perpendicular to base body 31 connecting combs 45 is provided.

This prevents warpage more reliably from occurring when resin molded article 100 is produced.

In the present exemplary embodiment, thin plate 32 (that is, an example of the intersection wall) is formed to project downward (more specifically, toward one side on which combs 45 extend) from lower surface 312 of base body 31. Thus, when resin molded article 100 is produced, thin plate 32 (that is, an example of the intersection wall) prevents occurrence of warpage in a direction in which the distance between combs 45 is shortened.

When the occurrence of warpage in a direction in which the distance between combs 45 is shortened can be prevented, tip 70a of each of the pair of sandwiching walls 70 can be prevented from opening outward in the Y direction (that is, the width direction and the third direction). With this configuration, the weakening of the engagement force between engagement projection 74 (that is, an example of the engagement part) and engagement recess 22111 (that is, an example of the engaged part) is prevented, and attachment 3 can be more reliably attached to hair clipper 1.

In the case of forming such thin plate 32 (that is, an example of the intersection wall), plate thickness T2 is preferably smaller than plate thickness T1. This is because thin plate 32 (that is, an example of the intersection wall) can be solidified earlier than other portions (for example, base body 31 and comb part 40) when resin molded article 100 is produced, and occurrence of warpage can be more reliably suppressed.

In the present exemplary embodiment, plate thickness T2 is set to be a thickness of ⅓ to ½ of plate thickness T1. With this configuration, the solidification of thin plate 32 (that is, an example of the intersection wall) can be accelerated while maintaining the strength of thin plate 32 (that is, an example of the intersection wall).

In addition, when thin plate 32 (that is, an example of the intersection wall) is provided, the strength of attachment 3 can be further improved, and thus shape stability of attachment 3 can be further improved.

In addition, when attachment 3 is formed using a synthetic resin material, unevenness (for example, unevenness formed to keep the thickness of comb part 40 of attachment 3 uniform and unevenness provided to prevent occurrence of sink marks) formed when attachment 3 is produced through resin molding appears in the appearance, and the appearance may be deteriorated.

In the present exemplary embodiment, a pair of extension walls 80 are formed on base plate 30 (that is, an example of the base) to extend from base plate 30 (that is, an example of the base) toward the other side (more specifically, the lower side) in the Z direction (that is, the up-down direction and the first direction), and the pair of extension walls 80 are formed continuously with the pair of sandwiching walls 70.

With this configuration, unevenness (for example, unevenness formed to keep the thickness of comb part 40 of attachment 3 uniform and unevenness provided to prevent occurrence of sink marks) formed when attachment 3 is produced through resin molding can be hidden by the pair of extension walls 80, and the appearance of attachment 3 can be further improved.

At this time, by continuously forming the pair of sandwiching walls 70 and the pair of extension walls 80 with a small curvature, the side surface of attachment 3 becomes flatter, and it is possible to prevent the side portion of attachment 3 from greatly bulging.

In the present exemplary embodiment, the pair of extension walls 80 have a lower end surface having a shape similar to the shape of skin contact surface 42 of comb part 40 in side view, and the lower end surface is formed to be positioned above skin contact surface 42 of comb part 40. Thus, in the present exemplary embodiment, the lower end surface of the pair of extension walls 80 serves as skin contact surface 81 that faces skin S in such a manner that a space is formed between skin contact surface 81 and skin contact surface 42 in a state where skin contact surface 42 of comb part 40 is in contact with skin S.

Further, in the present exemplary embodiment, the pair of extension walls 80 include side surface 82. Side surface 82 includes side portion 821 having a relatively small curvature and continuous part 822 formed continuously with front and rear portions of side portion 821 and having a relatively large curvature. The continuous parts 822 positioned in the front-rear direction are linked to first tip 51a of first comb 51 positioned on the outermost side and second tip 61a of second comb 61 positioned on the outermost side, respectively.

With this configuration, the pair of extension walls 80 having a shape of a comb serve as a dummy comb.

Further, in the present exemplary embodiment, as illustrated in FIGS. 8 and 11, recess 90 open to the other side (more specifically, the lower side) in the Z direction (that is, the up-down direction and the first direction) is formed between each of the pair of extension walls 80 and comb part 40. That is, recess 90 elongated in the X direction (that is, the front-rear direction and the second direction) is formed between each of the pair of extension walls 80 linked in the front-rear direction and comb 45 positioned at the outermost side.

With this configuration, short hair is allowed to enter recess 90 formed between each of the pair of extension walls 80 and comb part 40 when hair clipper 1 to which attachment 3 has been attached is used. This further reduces the resistance generated when attachment 3 is used in contact with skin. As a result, the usability of attachment 3 can further improve.

In addition, with the configuration in which short hair is allowed to enter recess 90 between each of the pair of extension walls 80 and comb part 40, when hair clipper 1 to which attachment 3 has been attached is used, hair H (that is, an example of body hair) is prevented from being pulled by attachment 3 in a crushed state. This prevents hair H (that is, an example of body hair) to be damaged by attachment 3.

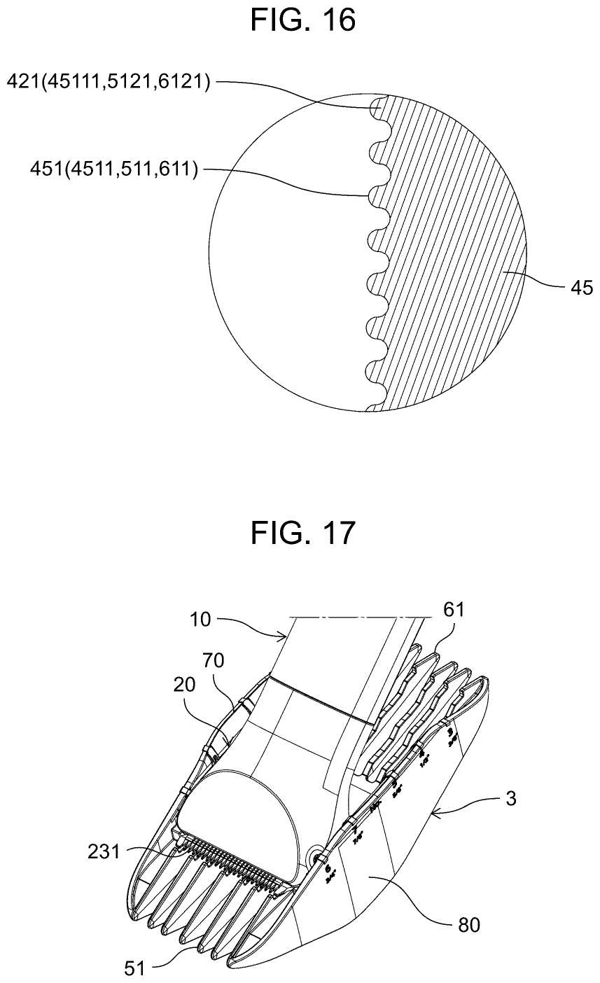

FIG. 16 is an enlarged view illustrating textured part 421 formed on comb part 40 in an example of attachment 3 according to the exemplary embodiment. In the present exemplary embodiment, as illustrated in FIGS. 14 to 16, textured part 421 (that is, an example of an uneven part) having unevenness is formed by performing texturing on skin contact surface 42 of comb part 40. With this configuration, the frictional force generated between skin S and skin contact surface 42 is reduced, the sliding properties of skin contact surface 42 on skin S is further improved, and the resistance feeling felt when attachment 3 is used is reduced.

The textured part 421 (that is, an example of the uneven part) can be formed by performing a so-called texturing, in which the textured part is generated by performing physical surface treatment such as etching or sandblasting on the surface of the mold and transferring the surface to attachment 3. At this time, the calculated average roughness (Ra) of skin contact surface 42 is preferably 1.0 μm to 4.50 μm. As a result, comfort during use of attachment 3 can further improve.

In the present exemplary embodiment, first textured part 5121 (that is, an example of a first uneven part) is formed on first skin contact surface 512 of first comb 51, and second textured part 6121 (that is, an example of a second uneven part) is formed on second skin contact surface 612 of second comb 61. Further, linking lower end surface 4511 linking first skin contact surface 512 to second skin contact surface 612 is also textured, and a linking textured part 45111 (that is, an example of the uneven part) is formed on linking lower end surface 4511. That is, in the present exemplary embodiment, lower end surface 451 of comb 45 includes first skin contact surface 512, second skin contact surface 612, and linking lower end surface 4511 linking first skin contact surface 512 to second skin contact surface 612. Textured part 421 (that is, an example of the uneven part) is formed over entire lower end surface 451 of comb 45.

In the present exemplary embodiment, the surface roughness of side surface 452 of comb 45 is smaller than the surface roughness of lower end surface 451 of comb 45. That is, side surface 452 of comb 45 is smoother than lower end surface 451.

With this configuration, hair H (that is, one example of body hair) can be more easily introduced into the space formed between combs 45 adjacent to each other.

Next, an example of a use method in a state where attachment 3 having such a configuration is attached to head 20 will be described.

First, head 20 is attached to body 10, and power transmission unit 241 is attached to drive shaft 16. Attachment 3 is attached to head 20 by engaging any one engagement projection 74 (that is, an example of the engagement part) among five engagement projections 74 (that is, an example of the engagement parts) with engagement recess 22111 (that is, an example of the engaged part) of head 20. The attachment of head 20 to body 10 may be performed earlier than the attachment of attachment 3 to head 20. Alternatively, the attachment of attachment 3 to head 20 may be performed earlier than the attachment of head 20 to body 10.

Then, in this state, power switch 123 is pressed to drive rotary motor 15, whereby drive shaft 16 is rotated.

In this way, the rotation of drive shaft 16 is transmitted to power transmission unit 241, and power transmission unit 241 rotates together with drive shaft 16. At this time, operation shaft 242 attached to power transmission unit 241, base 2441 attached to operation shaft 242, and eccentric shaft 2442 attached to base 2441 also rotate together with power transmission unit 241. When eccentric shaft 2442 rotates, link 2443 attached to eccentric shaft 2442 reciprocates linearly in the width direction.

As above, when link 2443 reciprocates linearly in the width direction, only the force in the width direction is transmitted from link 2443 to connection part 2351, and holding plate 235 reciprocates linearly in the width direction. At this time, movable plate 233 supported by holding plate 235 also reciprocates linearly in the width direction, and movable blade 2331 provided on movable plate 233 slides (more specifically, reciprocates linearly) in the width direction in a state where while movable blade 2331 is in contact with fixed blade 2321.

Thus, movable blade 2331 and fixed blade 2321 cooperate to cut hair (more specifically, hair H) at a desired cutting height.

Instead of using one type of attachment 3, a plurality of types of attachments 3 that can set different cutting heights may be provided, and desired attachment 3 can be selectively attached to hair clipper 1.

### [Modification of Configuration of Attachment]

Next, a modification of attachment 3 will be described.

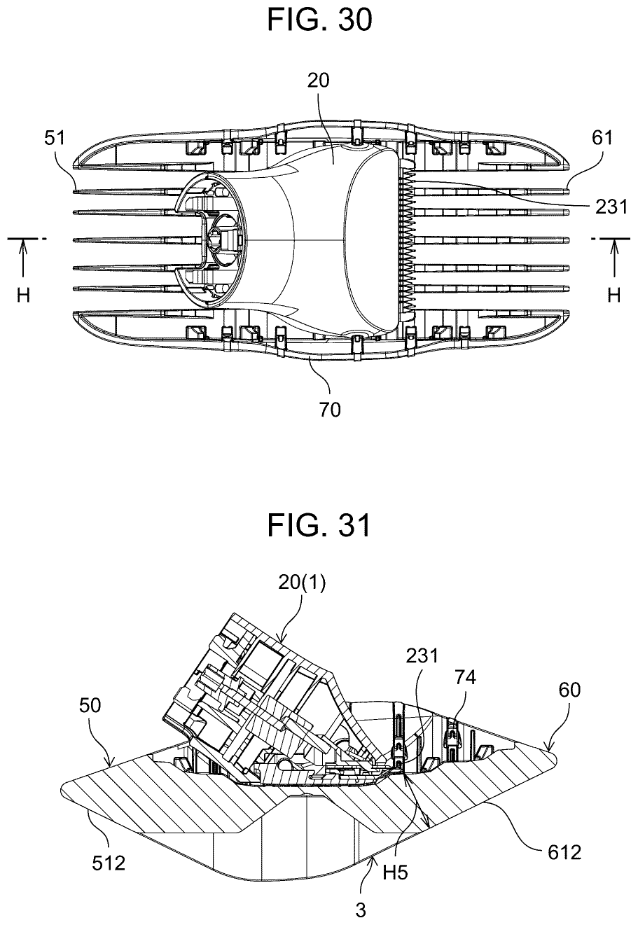

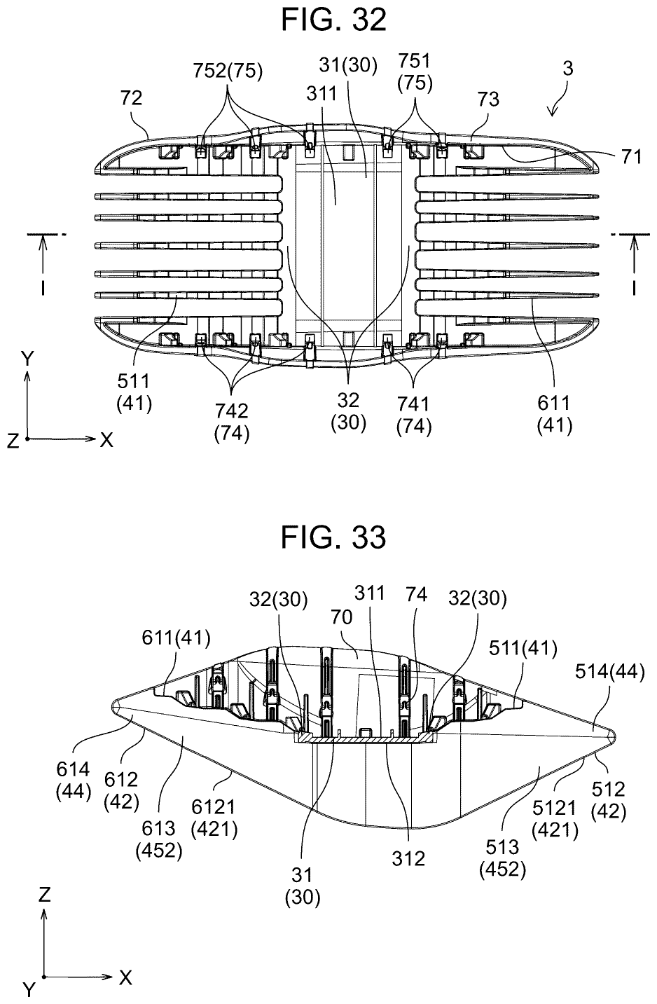

FIG. 29 is a perspective view schematically illustrating a state in which the engaged part (for example, engagement recess 22111) of the cutting device (for example, hair clipper 1) is engaged with the engagement part which is provided close to the base and is included in second selective engagement group 752 provided in an example of attachment 3 according to the exemplary embodiment. FIG. 30 is a plan view schematically illustrating the state in which the engaged part (for example, engagement recess 22111) of the cutting device (for example, hair clipper 1) is engaged with the engagement part which is provided close to the base and included in second selective engagement group 752 provided in an example of attachment 3 according to the exemplary embodiment. FIG. 31 is a sectional view taken along line H-H in FIG. 30. FIG. 32 is a plan view illustrating attachment 3 according to a first modification. FIG. 33 is a sectional view taken along line I-I in FIG. 32. FIGS. 32 and 33 illustrate attachment 3 according to the first modification.

As illustrated in FIGS. 32 and 33, attachment 3 according to the first modification is formed in a state where the pair of thin plates 32 (that is, an example of the intersection wall) projects upward from upper surface 311 of base body 31. All combs 45 are linked by thin plate 32 (that is, an example of the intersection wall).

As above, when the pair of thin plates 32 (that is, an example of the intersection wall) is formed in a state of projecting upward from upper surface 311 of base body 31, thin plates 32 (that is, an example of the intersection wall) prevent occurrence of warpage in a direction in which the distance between the pair of sandwiching walls 70 is shortened in producing resin molded article 100.

When occurrence of warpage in a direction in which the distance between the pair of sandwiching walls 70 is shortened can be prevented, the tip (more specifically, skin contact surface 42) of comb 45 can be prevented from opening outward in the Y direction (that is, the width direction and the third direction).

Thus, also by using attachment 3 illustrated in FIGS. 32 and 33, it is possible to more reliably prevent the occurrence of warpage at the time of producing resin molded article 100.

The pair of thin plates 32 (that is, an example of the intersection wall) may be formed in a state of projecting upward from upper surface 311 of base body 31 and also projecting downward from lower surface 312 of base body 31. With this configuration, the occurrence of warpage can be more reliably suppressed when resin molded article 100 is produced.

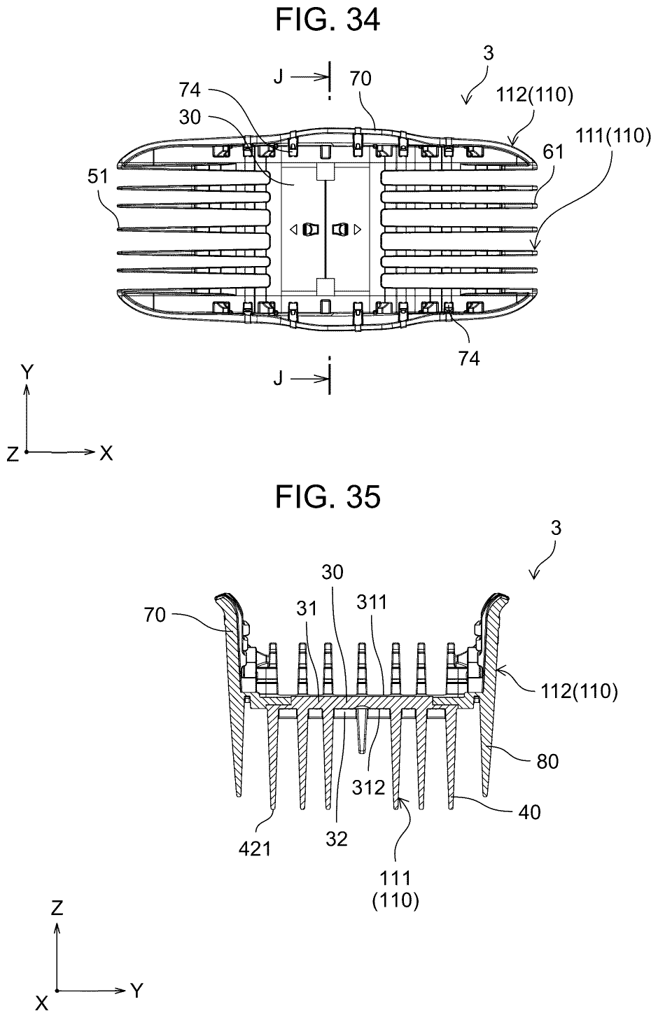

FIG. 34 is a plan view illustrating attachment 3 according to a second modification. FIG. 35 is a sectional view taken along line J-J in FIG. 34. FIGS. 34 and 35 illustrate attachment 3 according to the second modification.

As illustrated in FIGS. 34 and 35, attachment 3 according to the second modification is formed by assembling two or more members.

Specifically, attachment 3 according to the second modification is resin assembly 110 formed by assembling comb member 111 to be comb part 40 and holding member 112 to be the pair of the sandwiching walls 70 and the pair of extension walls 80 that hold comb part 40.

As above, when attachment 3 is formed by assembling two or more members, comb part 40 can be made of a more optimal material, and the pair of sandwiching walls 70 can be made of a more optimal material. That is, attachment 3 can be produced using a material optimum for each function.

For example, holding member 112 (more specifically, the pair of sandwiching walls 70 and the pair of extension walls 80) may be made of polyoxymethylene (hereinafter, referred to as “POM”) having relatively high abrasion resistance, and comb member 111 (more specifically, the base (for example, base plate 30) and comb part 40) may be made of an acrylonitrile-butadiene-styrene copolymer (hereinafter, referred to as “ABS resin”) that is relatively hardly deformed.

With this configuration, the strength of comb part 40 is increased, and the workability of attaching and detaching attachment 3 to and from hair clipper 1 can be improved.

At this time, it is preferable to form resin assembly 110 by assembling the members in a state where each member (for example, comb member 111 and holding member 112) can be detached.

As above, when resin assembly 110 is assembled in a state where each member (for example, comb member 111 and holding member 112) can be detached, comb members 111 having different cutting heights can be replaced with holding member 112. Thus, variations in the cutting height of attachment 3 can further increase.

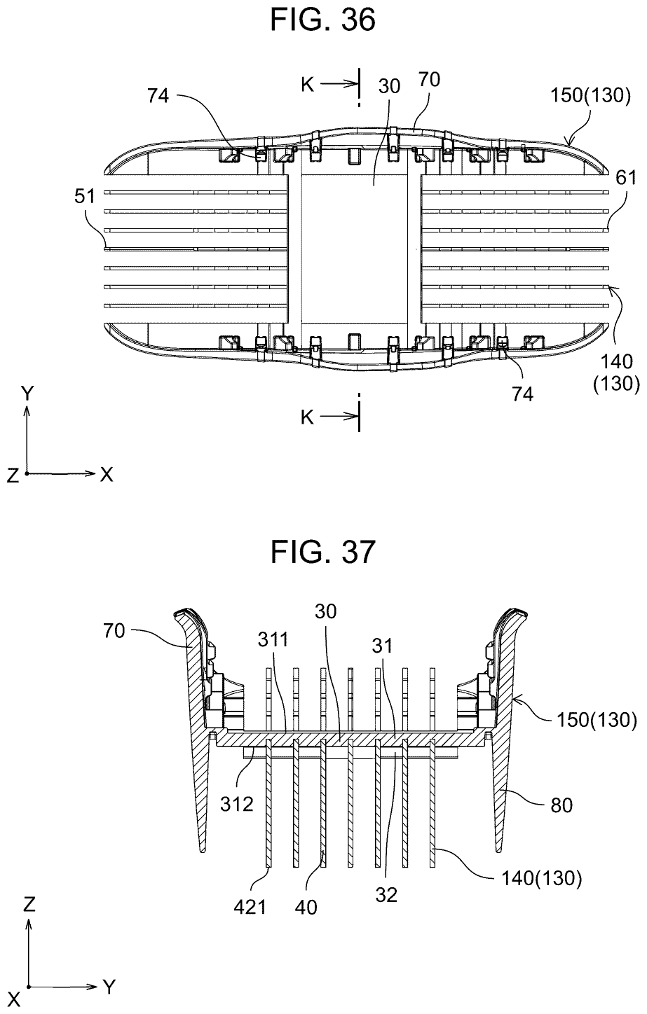

FIG. 36 is a plan view illustrating attachment 3 according to a third modification. FIG. 37 is a sectional view taken along line K-K in FIG. 36. FIGS. 36 and 37 illustrate attachment 3 according to the third modification.

As illustrated in FIGS. 36 and 37, attachment 3 according to the third modification is insert-molded article 130 in which metallic comb part 40 as insert member 140 and base plate 30 (that is, an example of the base) as filling resin 150 are integrated.

This allows the comb 45 of attachment 3 to be thinner to improve hair regulating property and the strength of comb part 40.

### (Supplementary Note)

The above description of the exemplary embodiments discloses following techniques.

### (Technology 1)

An attachment for a cutting device including a blade part, the attachment being configured to be attached to and detached from the cutting device by moving the attachment in a first direction relatively to the cutting device, the attachment comprising: a base; a comb part including a facing surface and a skin contact surface, the facing surface being configured to face the blade part, the skin contact surface being configured to come into contact with a skin, the base being provided with the comb part, the comb part projecting in a second direction intersecting the first direction; and a pair of sandwiching walls, the base being provided with the pair of sandwiching walls, the pair of sandwiching walls being configured to sandwich the cutting device in a third direction which intersects the first direction and the second direction, wherein the skin contact surface is provided with an uneven part.

By providing the uneven part on the skin contact surface like this, the contact area between the skin contact surface and the skin is reduced, and the frictional force to be generated between the skin contact surface and the skin can be reduced. As a result, the sliding properties of the skin contact surface on the skin can be further improved.

### (Technology 2)

The attachment of a cutting device according to Technology 1, wherein the uneven part is a textured part formed by performing texturing on the skin contact surface.

By forming the uneven part by performing texturing on the skin contact surface like this, the uneven part can be more easily formed on the skin contact surface. In addition, by forming the textured part on the skin contact surface, fine uneven part can be formed substantially uniformly over the entire surface of the skin contact surface, and thus, the sliding properties of the skin contact surface on the skin can be more reliably improved.

### (Technology 3)

The attachment of a cutting device according to Technology 1 or Technology 2, wherein the comb part includes a side surface with a surface roughness smaller than a surface roughness of the skin contact surface.

With this configuration, it is possible to prevent the side surface of the comb part from blocking the introduction of hair into the blade part. As a result, hair passing of hair to be introduced into the blade part is improved, and hair can be more efficiently cut to a desired uniform length.

### (Technology 4)

The attachment of a cutting device according to any one of Technology 1 to Technology 3, wherein the pair of sandwiching walls extend from the base toward one side of the first direction, the base is provided with a pair of extension walls each extending from the base toward the other side of the first direction, the comb part extends from the base toward the other side of the first direction between the pair of extension walls in the third direction, and the pair of extension walls are formed continuously with the pair of sandwiching walls.

With this configuration, for example, unevenness (unevenness formed to keep the thickness of the attachment uniform, unevenness provided to prevent generation of sink marks, or the like) formed when the attachment is produced through resin molding can be hidden by the extension wall. As a result, the appearance of the attachment can further improve.

### (Technology 5)

The attachment of a cutting device according to Technology 4, wherein a recess which opens to the other side of the first direction is formed between each of the extension walls and the comb part.

With this configuration, when the cutting device to which the attachment is attached is used, short hair is allowed to enter the recess between each of the extension walls and the comb part. Thus, the resistance generated when the attachment is used in contact with the skin can be further reduced, and the usability of the attachment can be further improved.

In addition, when short hair is allowed to enter the recess between each of the extension walls and the comb part, the influence of the attachment on the hair can be reduced as compared with the case where the attachment is slid on the skin in a state where the hair is crushed by the wall between each of the extension walls and the comb part. For example, when the attachment is slid on the skin in a state where the hair is crushed by the wall between each of the extension walls and the comb part, the crushed hair is pulled by the attachment, and the hair may be damaged. However, when the hair is allowed to enter the recess between each of the extension walls and the comb part, the hair is prevented from being pulled by the attachment. Thus, the damage to be given to the hair by the attachment can be further reduced.

### (Technology 6)

A cutting device to which the attachment of a cutting device according to any one of Technology 1 to Technology 5 is attached.

With this configuration, a cutting device to which an attachment is attached can be obtained, the cutting device being able to more reliably suppress variation in cutting height when cutting hair to achieve a selected cutting height while enabling the cutting height to be selectively changed.

### [Others]

Although the contents of the attachment and the cutting device to which the attachment according to the present disclosure is attached have been described above, the present disclosure is not limited to these descriptions, and it is obvious to those skilled in the art that various modifications and improvements can be made.

For example, the present disclosure can be applied to exemplary embodiments in which changes, replacements, additions, omissions, and the like of the configurations described in the above exemplary embodiment and the modifications thereof are made. It is also possible to set a new exemplary embodiment by combining constituent elements described in the above exemplary embodiment and the modifications thereof.

In the above exemplary embodiment and the modifications thereof, a hair clipper for cutting human hair, animal hair, and the like is exemplified as the cutting device to which the attachment is attached, but the present disclosure can also be applied to an attachment to be attached to another cutting device such as a beard trimmer.

In the above exemplary embodiment and the modifications thereof, attachment 3 including first comb part 50 and second comb part 60 has been exemplified, but the attachment may include only one comb part.

In addition, the present disclosure can be applied to a slidable attachment, and the present disclosure can be applied to an attachment with which a cutting height is not adjusted (an attachment in which only one cutting height is set).

Base plate (base) 30 does not have to include thin plate (intersection wall) 32.

In the above exemplary embodiment and the modifications thereof, hair clipper 1 of a type in which head 20 is detachably attached to body 10 has been described as an example. However, hair clipper 1 may be a hair clipper (cutting device) in which a body and a head are integrated.

The head of the hair clipper can also be used as one of personal care kits to which heads having various functions (head of electric toothbrush, head of electric razor, and the like) can be attached to a common body.

Further, specifications (shape, size, layout, and the like) of the base, the sandwiching wall, and other details can be changed as appropriate.

Since the attachment and the cutting device according to the present disclosure can further improve the sliding properties of the skin contact surface on the skin as described above, the attachment and the cutting device can be used as various attachments and cutting devices for home use and business use.

What is claimed is:

1. An attachment for a cutting device including a blade part, the attachment being configured to be attached to and detached from the cutting device by moving the attachment in a first direction relatively to the cutting device, the attachment comprising:
a base;
a comb part including a facing surface and a skin contact surface, the facing surface being configured to face the blade part, the skin contact surface being configured to come into contact with a skin, the base being provided with the comb part, the comb part projecting in a second direction intersecting the first direction; and
a pair of sandwiching walls, the base being provided with the pair of sandwiching walls, the pair of sandwiching walls being configured to sandwich the cutting device in a third direction which intersects the first direction and the second direction,
wherein
the skin contact surface is provided with an uneven part.

2. The attachment of a cutting device according to claim 1, wherein
the uneven part is a textured part formed by performing texturing on the skin contact surface.

3. The attachment of a cutting device according to claim 1, wherein
the comb part includes a side surface with a surface roughness smaller than a surface roughness of the skin contact surface.

4. The attachment of a cutting device according to claim 1, wherein
the pair of sandwiching walls extend from the base toward one side of the first direction,
the base is provided with a pair of extension walls each extending from the base toward the other side of the first direction,
the comb part extends from the base toward the other side of the first direction between the pair of extension walls in the third direction, and
the pair of extension walls are formed continuously with the pair of sandwiching walls.

5. The attachment of a cutting device according to claim 4, wherein
a recess which opens to the other side of the first direction is formed between each of the extension walls and the comb part.

6. A cutting device to which the attachment of the cutting device according to claim 1 is attached.
